(19) United States
(12) Patent Application Publication
(10) Pub. No.: US 2006/0050686 A1
(43) Pub. Date: Mar. 9, 2006

(54) Software platform for developing, delivering and managing data-voice applications operating on an internet protocol (IP) phone

(75) Inventors: Carlos Javier Velez-Rivera, Cabo Rojo, PR (US); Inaki J. Olivares-Arocho, Mayaguez, PR (US); Walter E. Vale-Sanchez, Aguada, PR (US); Miguel Angel Sosa Rojas, Mayaguez, PR (US); Jose L. Cruz Rivera, Mayaguez, PR (US)

Correspondence Address: RUBEN C. DELEON;WINSTEAD SECHROST & MINICK P.C., P.O. BOX 50784, DALLAS, TX, 75201, US

(73) Assignee: Commoca, Inc., Mayaguez, PR (US)

(21) Appl. No.: 11/219,934

(22) Filed: Sep. 6, 2005

Related U.S. Application Data
(60) Provisional application No. 60/608,223, filed on Sep. 8, 2004.

(51) Int. Cl. H04L 12/66

(52) U.S. Cl. 370/352

(57) ABSTRACT

A software platform in an Internet Protocol (IP) phone having the ability to be used with different communication infrastructures such as broadband, wireless communication and Plain Old Telephone System (POTS) service. Further, the software platform in the IP phone is used in conjunction with a communication architecture, referred to herein as the Transaction Applications Delivery Services (TADS) communications architecture, that provides the ability to develop, deliver and manage data-voice applications operating on the IP phone.

### CROSS REFERENCE TO RELATED APPLICATION

This application claims priority to and benefit of U.S. Provisional Application Ser. No. 60/608,223, entitled “Transactional Application Delivery System for Converged Communication Devices,” filed Sep. 8, 2004, and claims the benefit of its earlier filing date under 35 U.S.C. §119(e).

### BACKGROUND OF THE INVENTION

1. Technical Field

The present invention relates to the field of an internet phone system, and more particularly to a software platform for developing, delivering and managing data-voice applications operating on an Internet Protocol (“IP”) phone.

2. Background of Invention

Recently, multimedia communication in which voice, video and data information are transmitted and received using the Internet Protocol (IP) is carried over an IP network. A phone, referred to herein as an “IP phone” or more generally as a “converged communications terminal”, may be connected directly to the IP network over which a multimedia phone exchange system can be constructed. An IP phone is a telephone which can operate and execute voice communication in the same way as conventional telephones either via a Plain Old Telephone System (POTS) or an IP network. Further, the IP phone can use the IP network for data applications. For example, IP phones may be connected to an IP network, such as a local area network, in an office environment thereby using the network as a private telephone network circuit and as a data exchange network. In another example, IP phones may use a wide area network, e.g., Internet, to communicate with other properly configured IP phones for data-voice exchanges. In another example, IP phones may use a data network for transactional data applications and the POTS network for voice.

IP phones currently have features similar to those found in traditional public switched telephone network (PSTN) phones such as call forwarding, call waiting, conference calls and so forth. Enhancements to these feature sets have been slow in coming, as market leaders in the “Voice over IP” (VoIP) telephony field have pursued an incremental approach to their product offerings, particularly because of the lack of computing power available in VoIP platforms. Currently, to ensure optimal user experience and cost-performance, VoIP platforms may have to be specifically designed for a target market area and software application (e.g., data-voice application) operating on the IP phone. By having to design and implement separate VoIP platforms for each application operating on the IP phone, the cost in operating different applications on an IP phone may be prohibitive.

Furthermore, service providers (referring to the providers that provide communications service for the IP phone to operate) and content providers (referring to the providers of data-voice applications that operate on the IP phone) do not currently have the ability to successfully develop, deploy, monitor, debug and upgrade data-voice applications that operate on an IP phone.

Therefore, there is a need in the art for an IP phone configured with a VoIP platform that can support different applications operating on the IP phone. Further, there is a need in the art for an ability to develop, deliver and manage data-voice applications operating on an IP phone.

### SUMMARY OF INVENTION

The problems outlined above may at least in part be solved in some embodiments by a software platform in an IP phone having the ability to be used with different communication infrastructures such as broadband, wireless communication, POTS service. Further, the software platform is used in conjunction with a communications architecture, referred to herein as the Transaction Applications Delivery Services (TADS) communications architecture, that provides the ability to develop, deliver and manage data-voice applications operating on the IP phone

In one embodiment of the present invention, a method for identifying phone numbers made by a user of an Internet Protocol (IP) phone that did not contact intended recipients may comprise the step of sending an error message to the IP phone by a server indicating a dialed phone number made by the user of the IP phone failed to connect. The method may further comprise receiving an alarm message from the IP phone indicating a phone number that did not contact an intended recipient. The method may further comprise incrementing a failure count for the phone number that did not contact the intended recipient. The method may further comprise flagging the phone number that did not contact the intended recipient if the failure count exceeds a threshold.

In another embodiment of the present invention, a method for identifying a failed directory search of a contact performed by a user of an Internet Protocol (IP) phone may comprise the step of sending an error message to the IP phone by a server indicating a directory search performed by the user of the IP phone failed to identify the contact with a phone number. The method may further comprise receiving an alarm message from the IP phone indicating an improper graphic. The method may further comprise incrementing a failure count for the searched contact. The method may further comprise flagging the directory search if the failure count exceeds a threshold.

In another embodiment of the present invention, a computer program product embodied in a machine readable medium for identifying phone numbers made by a user of an Internet Protocol (IP) phone that did not contact intended recipients may comprise the programming step of sending an error message to the IP phone by a server indicating a dialed phone number made by the user of the IP phone failed to connect. The computer program product may further comprise the programming step of receiving an alarm message from the IP phone indicating a phone number that did not contact an intended recipient. The computer program product may further comprise the programming step of incrementing a failure count for the phone number that did not contact the intended recipient. The computer program product may further comprise the programming step of flagging the phone number that did not contact the intended recipient if the failure count exceeds a threshold.

In another embodiment of the present invention, a computer program product embodied in a machine readable medium for identifying a failed directory search of a contact performed by a user of an Internet Protocol (IP) phone may comprise the programming step of sending an error message to the IP phone by a server indicating a directory search performed by the user of the IP phone failed to identify the contact with a phone number. The computer program product may further comprise the programming step of receiving an alarm message from the IP phone indicating an improper graphic. The computer program product may further comprise the programming step of incrementing a failure count for the searched contact. The computer program product may further comprise the programming step of flagging the directory search if the failure count exceeds a threshold.

In another embodiment of the present invention, a system may comprise a memory unit operable for storing a computer program operable for identifying phone numbers made by a user of an Internet Protocol (IP) phone that did not contact intended recipients. The system may further comprise a processor coupled to the memory unit, where the processor, responsive to the computer program, comprises circuitry for sending an error message to the IP phone by a server indicating a dialed phone number made by the user of the IP phone failed to connect. The processor may further comprise circuitry for receiving an alarm message from the IP phone indicating a phone number that did not contact an intended recipient. The processor may further comprise circuitry for incrementing a failure count for the phone number that did not contact the intended recipient. The processor may further comprise circuitry for flagging the phone number that did not contact the intended recipient if the failure count exceeds a threshold.

In another embodiment of the present invention, a system may comprise a memory unit operable for storing a computer program operable for identifying a failed directory search of a contact performed by a user of an Internet Protocol (IP) phone. The system may further comprise a processor coupled to the memory unit, where the processor, responsive to the computer program, comprises circuitry for sending an error message to the IP phone by a server indicating a directory search performed by the user of the IP phone failed to identify the contact with a phone number. The processor may further comprise circuitry for receiving an alarm message from the IP phone indicating an improper graphic. The processor may further comprise circuitry for incrementing a failure count for the searched contact. The processor may further comprise circuitry for flagging the directory search if the failure count exceeds a threshold.

In another embodiment of the present invention, a method may comprise the step of receiving a first wakeup call to an Internet Protocol (IP) phone from a server. The method may further comprise receiving one or more of reminders, alerts, newspaper material and a list of information categories from the server if the first wakeup call is confirmed by a user of the IP phone. The method may further comprise receiving a second wakeup call after a particular time period specified in the user's profile if the first wakeup call is not confirmed by the user of the IP phone.

In another embodiment of the present invention, a method for contacting a merchant of an advertisement displayed on an Internet Protocol (IP) phone may comprise the step of receiving an advertisement on a webpage displayed on the IP phone, where the advertisement on the webpage includes session initiation protocol (SIP) based uniform resource identifiers (URIs). The method may further comprise selecting the advertisement. The method may further comprise passing a URI associated with the selected advertisement by a web browser of the IP phone to an application of the IP phone. The method may further comprise generating a call to a merchant associated with the selected advertisement based on the URI associated with the selected advertisement by the application of the IP phone.

In another embodiment of the present invention, a method for generating a conference call from an Internet Protocol (IP) phone may comprise the step of creating a conference call meeting profile containing contact information for all conference participants in response to scheduling a meeting. The method may further comprise sending the conference call meeting profile to a first phone application of the IP phone, where the first phone application is configured to maintain a calendar of a first user of the IP phone. The method may further comprise executing the conference call meeting profile. The method may further comprise instructing the IP phone to generate a conference call to the conference participants identified in the profile.

In another embodiment of the present invention, a method for establishing a conference call with an Internet Protocol (IP) phone may comprise the step of storing a conference call meeting profile containing contact information for all conference participants, where the conference call meeting profile comprises a set of instructions which are to be followed upon activation of the conference call meeting profile. The method may further comprise receiving an indication to start a conference call associated with the conference call meeting profile. The method may further comprise activating the conference call meeting profile. The method may further comprise inviting each of the conference participants to establish communication with the IP phone.

In another embodiment of the present invention, a method for controlling content distribution to and from an Internet Protocol (IP) phone may comprise the step of storing profile preferences of a profile in a database, where the profile preferences of the profile comprises rules as to which telephone calls and content are allowed to be received by a user of the IP phone and which telephone calls and content are forbidden to be received by the user of the IP phone. The method may further comprise associating the profile with a schedule, where the schedule enables different telephone calls and content to be received and forbidden at different times during the day. The method may further comprise receiving a request to send content to the user of the IP phone. The method may further comprise determining if the user of the IP phone is allowed to receive the content based on the profile preferences of the profile.

In another embodiment of the present invention, a method for controlling content distribution to and from an Internet Protocol (IP) phone may comprise the step of storing profile preferences of a profile in a database, where the profile preferences of the profile comprises rules as to which telephone calls and content are allowed to be received by a first user of an IP phone and which telephone calls and content are forbidden to be received by the first user of the IP phone. The method may further comprise associating the profile with a schedule, where the schedule enables different telephone calls and content to be received and forbidden at different times during the day. The method may further comprise receiving a request by a second user to telephonically connect to the first user of the IP phone. The method may further comprise determining if the first user of the IP phone is allowed to telephonically connect to the second user based on the profile preferences of the profile.

In another embodiment of the present invention, a method for a user to access content on an Internet Protocol (IP) phone from a hotel may comprise the step of generating a content package to be displayed on the IP phone, where the content packages comprise customized content, where the content package comprises one or more of the following: check-in/check-out assistance and information, billing information, room service orders, and concierge services information. The method may further comprise transmitting the content package to the IP phone. The method may further comprise providing a user of the IP phone with controls to access content of the generated content package.

In another embodiment of the present invention, a method for facilitating the management of directory updates may comprise the step of generating a validation code in response to a vendor performing one or more of updating, correcting and setting up a contact information associated with a phone line of interest. The method may further comprise sending the validation code along with a telephone number to call to an e-mail address of the vendor. The method may further comprise generating one or more of an electronic mail and a facsimile. The method may further comprise sending the one or more of the electronic mail and the facsimile to the vendor indicating that the phone line contact information has been successfully updated.

In another embodiment of the present invention, a method for assigning content to Internet Protocol (IP) phones may comprise the step of storing content created by an administrator on a database repository. The method may further comprise assigning profiles to phone groups. The method may further comprise reading content identifications from the database repository and assigning the read content identifications to the phone groups. The method may further comprise returning content corresponding to a requested identification.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a system implementing a multi-layer fixed telephone system interacting with different communication infrastructures;

FIG. 2 illustrates a typical hardware configuration of an application and TADS server in accordance with an embodiment of the present invention;

FIG. 3 illustrates an embodiment of the present invention of an external configuration of an IP phone;

FIG. 4 illustrates a typical hardware configuration of the IP phone in accordance with an embodiment of the present invention;

FIG. 5 illustrates the software platform of the IP phone in accordance with an embodiment of the present invention;

FIG. 6 illustrates an embodiment of the present invention of the communication infrastructure services layer of the software platform of the IP phone;

FIG. 7 illustrates an embodiment of the present invention of the common converged communication base services layer of the software platform of the IP phone;

FIG. 8 illustrates the relationship between open-standard protocols and the TADS protocol family and services in accordance with an embodiment of the present invention;

FIG. 9 illustrates an embodiment of the present invention of the domain-specific application layer of the software platform of the IP phone;

FIG. 10 illustrates an embodiment of the present invention of an application hosting services (“AHS”) architecture using the software platform in the IP phone;

FIG. 11 illustrates an embodiment of the present invention of a client-server Transactional Applications Delivery System (TADS) communications architecture;

FIG. 12 illustrates an embodiment of the present invention of a transactional application delivery system server side elements;

FIG. 13 illustrates an embodiment of the present invention of a transactional application delivery system client side elements;

FIG. 14 illustrates an embodiment of the present invention of the server side of a transactional application delivery system;

FIG. 15 illustrates an embodiment of the present invention of the client side of a transactional application delivery system;

FIG. 16 is a flowchart of a method for creating and storing personal preferences or profiles via a configuration portal to a wakeup server in accordance with an embodiment of the present invention;

FIG. 17 is a high-level state machine diagram of the wakeup service in accordance with an embodiment of the present invention;

FIG. 18 shows the sequence of events associated with the IP phone automatically answering a wakeup call in accordance with an embodiment of the present invention;

FIG. 19 shows the sequence of events associated with a user answering a wakeup call in accordance with an embodiment of the present invention;

FIG. 20 shows how the wakeup service can remind the user of a special date in a calendar in accordance with an embodiment of the present invention;

FIG. 21 shows how the wakeup service can alert the user of special entertainment events in accordance with an embodiment of the present invention;

FIG. 22 shows how the wakeup service can send the user urgent unread e-mails or voicemails that arrived during the night and that may require immediate attention during the morning in accordance with an embodiment of the present invention;

FIG. 23 shows how the wakeup service can send the user the information that might be of interest while waking up in accordance with an embodiment of the present invention;

FIG. 24 shows the sequence of events associated with the selectable failure threshold for the manual solution for enhanced data integrity methods in accordance with an embodiment of the present invention;

FIG. 25 shows the sequence of events associated with the selectable failure threshold for the automatic solution for enhanced data integrity methods in accordance with an embodiment of the present invention;

FIG. 26 shows the detailed sequence of events associated with the selectable failure threshold applicable to both the manual and automatic methods in accordance with an embodiment of the present invention;

FIG. 27 is a flowchart of a method for facilitating the management of directory updates via vendor self-fulfillment in accordance with an embodiment of the present invention;

FIG. 28 shows the sequence of events associated with the “click to dial” enhanced merchant-customer interaction method in accordance with an embodiment of the present invention;

FIG. 29 shows the sequence of events associated with the “more information” enhanced merchant-customer interaction method in accordance with an embodiment of the present invention;

FIG. 30 shows the sequence of events associated with the auto-conference call phone synchronization solution in accordance with an embodiment of the present invention;

FIG. 31 shows the sequence of events associated with the auto-conference call phone subscription solution in accordance with an embodiment of the present invention;

FIG. 32 shows the sequence of events associated with the auto-conference call phone subscription solution in accordance with an embodiment of the present invention;

FIG. 33 shows the sequence of events associated with the usage control method in connection with content distribution scenarios in accordance with an embodiment of the present invention;

FIG. 34 shows the sequence of events associated with the usage control method in connection with call control scenarios in accordance with an embodiment of the present invention;

FIG. 35 shows the sequence of events associated with a method to facilitate the control and distribution of content to hospitality phones in accordance with an embodiment of the present invention;

FIG. 36 shows the sequence of events associated with assigning content to phones in accordance with an embodiment of the present invention;

FIG. 37 shows the sequence of events associated with updating existing content in accordance with an embodiment of the present invention;

FIG. 38 shows the sequence of events associated with handling local content requests in accordance with an embodiment of the present invention;

FIG. 39 shows the sequence of events associated with handling external content requests in accordance with an embodiment of the present invention;

FIG. 40 shows the sequence of events associated with handling PMS interaction in a hospitality setting in accordance with an embodiment of the present invention;

FIG. 41 shows another sequence of events associated with handling PMS interaction in a hospitality setting in accordance with an embodiment of the present invention when it is the PMS that initiates a request for the update of PMS information on a phone;

FIG. 42 shows the message exchange between a TADS server and an IP Phone during a software deployment and update operation in accordance with an embodiment of the present invention; and

FIG. 43 shows the message exchange between a TADS server and an IP Phone during a software configuration operation in accordance with an embodiment of the present invention.

### DETAILED DESCRIPTION OF THE INVENTION

Although the present invention is described with reference to an Internet Protocol (IP) phone it is noted that the principles of the present invention may be applied to any Internet connected device, such as an Internet appliance. It is further noted that embodiments applying the principles of the present invention to such Internet connected devices would fall within the scope of the present invention.

In the following description, numerous specific details are set forth to provide a thorough understanding of the present invention. However, it will be apparent to those skilled in the art that the present invention may be practiced without such specific details. In other instances, well-known circuits and software modules have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

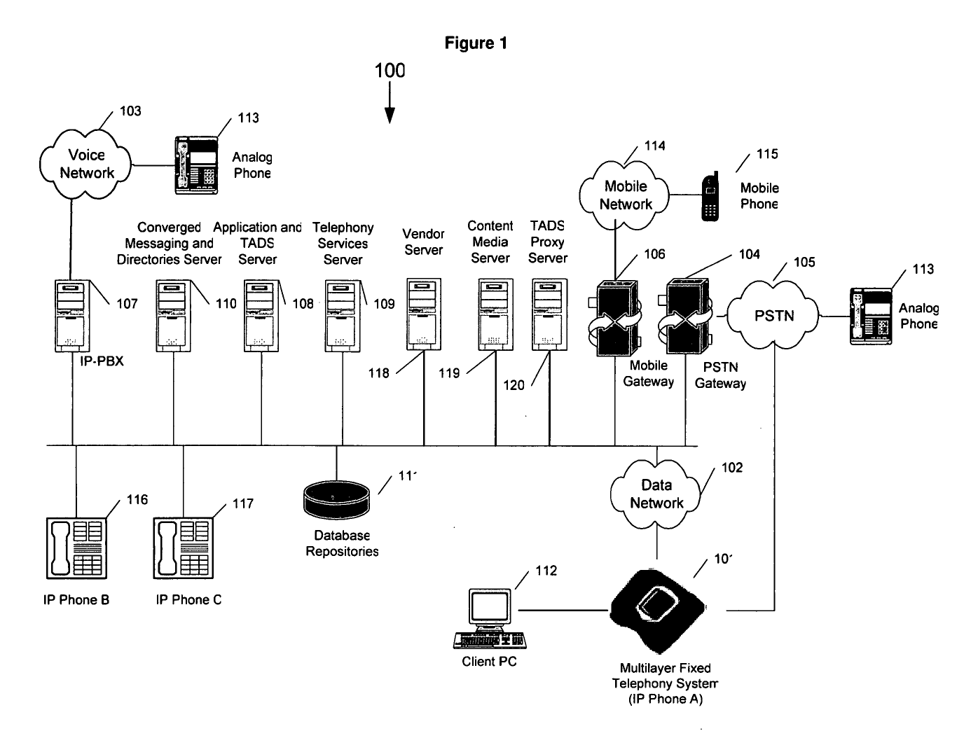

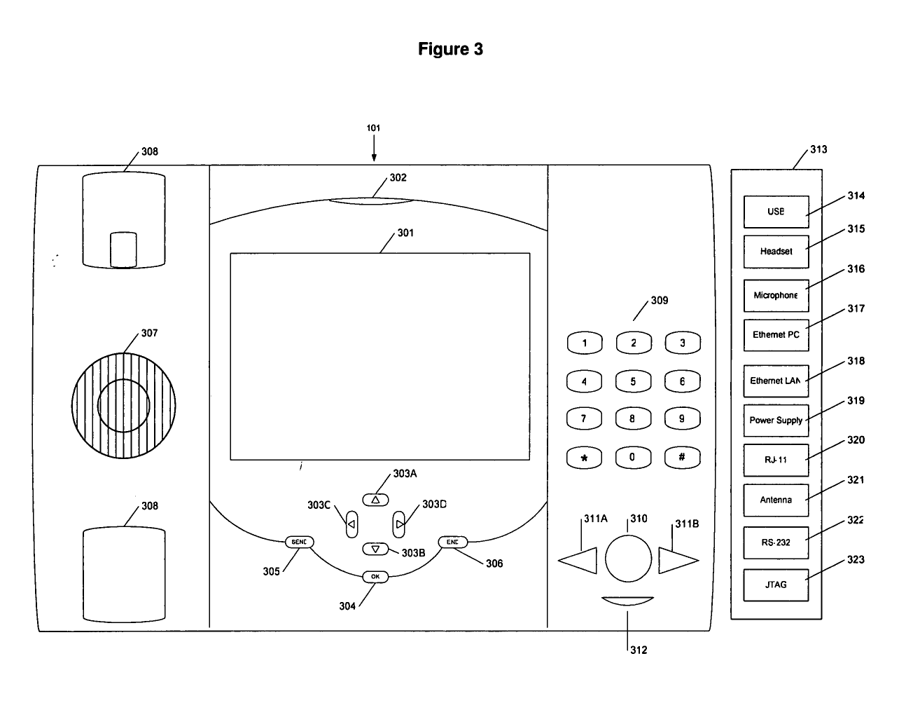

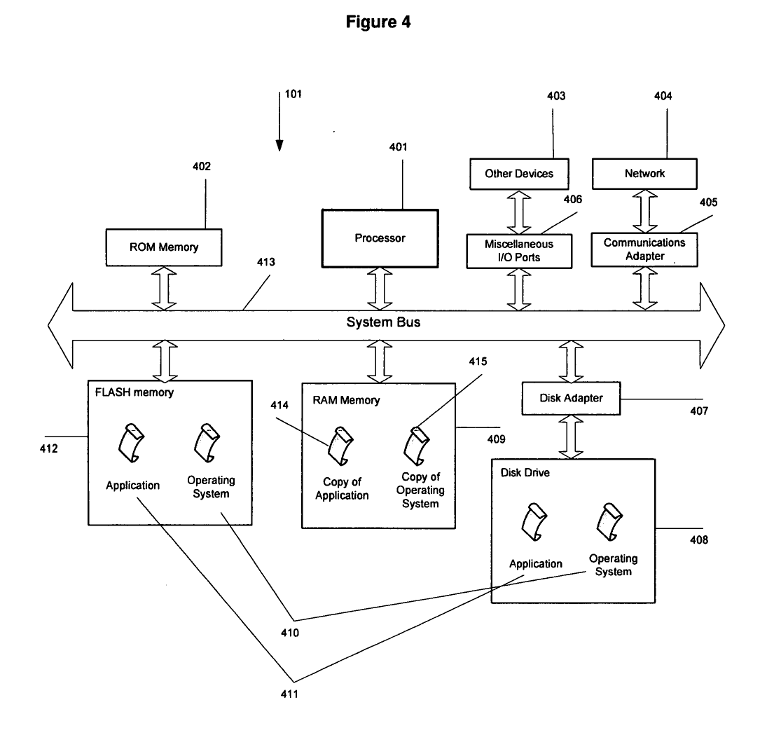

FIG. 1 illustrates a high level diagram of an embodiment of the present invention of a system 100 implementing a multi-layer fixed telephone system 101 interacting with different communication infrastructures. Referring to FIG. 1, system 100 allows multi-layer fixed telephone system 101 (referred to herein as a “IP phone A” or more generally as “IP Phone”) to interact with other entities over different communication infrastructures, such as data, voice, mobile and Public Switched Telephone Networks (PSTN) 102, 103, 114, 105, respectively, to provide telephony functions and run applications. A more detailed description of the external configuration of IP phone 101 is described below in association with FIG. 3. Further, a more detailed description of the hardware configuration of IP phone 101 is described further below in association with FIG. 4. In one embodiment, IP phone 101 may be coupled to a computer system 112, data network 102 and a Public Switched Telephone Network (PSTN) 105. IP phone 101 may communicate with third-party voice over IP (VoIP) terminals 116 and 117 (IP Phones B and C, respectively) via data network 102. IP phone 101 may further communicate with an analog phone 113 over PSTN 105. IP phone 101 may further communicate with analog phone 113 over voice network 103 via data network 102. Further, IP phone 101 may communicate with a mobile phone 115 over mobile network 114 via data network 102.

System 100 may further include a Public Switched Telephone Network (PSTN) Gateway 104 coupled to data network 102. PSTN gateway 104 may be configured to translate signaling and media between data network 102 coupled to IP phone 101 and PSTN 105. PSTN 105 may be coupled to conventional telephone 113. PSTN gateway 104 may allow IP phone 101 to communicate with standard analog telephones 113 in PSTN 105.

System 100 may further include a mobile gateway 106 coupled between data network 102 and mobile network 114. Mobile gateway 106 may be configured to translate signaling and media between data network 102 and mobile wireless network 114. Mobile network 114 may be coupled to mobile telephone 115. Mobile gateway 106 may allow IP phone 101 to communicate with mobile phones 115 in wireless network 114. IP phone 101 may signal mobile gateway 106 in order to enable calls destined to mobile telephone 115 to be terminated on IP phone 101.

System 100 may further include an Internet Protocol-Private Branch eXchange (IP-PBX) 107 coupled to data network 102, voice network 103 and analog phones 113 or VoIP phone 116. IP-PBX 107 may be configured to interconnect voice and data networks 103, 102, respectively, in an enterprise environment and provide centralized call control functionality.

System 100 may further include a telephony services server 109 coupled to data network 102. Telephony services server 109 may be configured to provide services that allow IP phone 101 to communicate with other analog and VoIP terminals and extend its range of available telephony features.

System 100 may further include a converged messaging and directory server 110 coupled to data network 102. Converged messaging and directory server 110 may be configured to contain all the components necessary to provide the user with a unified converged platform to send and receive electronic and voice mail messages. In addition, server 110 may provide IP phone 101 with access to personal and public contact directories.

System 100 may further include a vendor server 118 coupled to data network 102. Vendor server 118 may be configured to allow end-users to access and purchase goods and services via IP phone 101.

System 100 may further include a content and media server 119 coupled to data network 102. Content media server 119 may be configured to allow end-users access to media content via IP phone 101.

System 100 may further include a TADS proxy server 120 coupled to data network 102. TADS Proxy Server 120 can be placed in front of two or more TADS servers to achieve load balancing and redundancy.

System 100 may further include a database repository 111 coupled to data network 102. Database repository 111 may be configured to manage and provide IP phone 101 and servers 107, 108, 109, 110, 119 and 120 with data needed to perform their tasks.

System 100 may further include an application server 108 coupled to data network 102. Application server 108 may be configured to contain the server side components (discussed further below) of client/server applications accessed through IP phone 101, such as the components of the Transactional Application Delivery System (TADS) (discussed further below).

It is noted that FIG. 1 is illustrative and that not all of the components of system 100 were depicted for the sake of brevity (e.g., provisioning and configuration servers). It is further noted that system 100 is not to be limited in scope to the system disclosed.

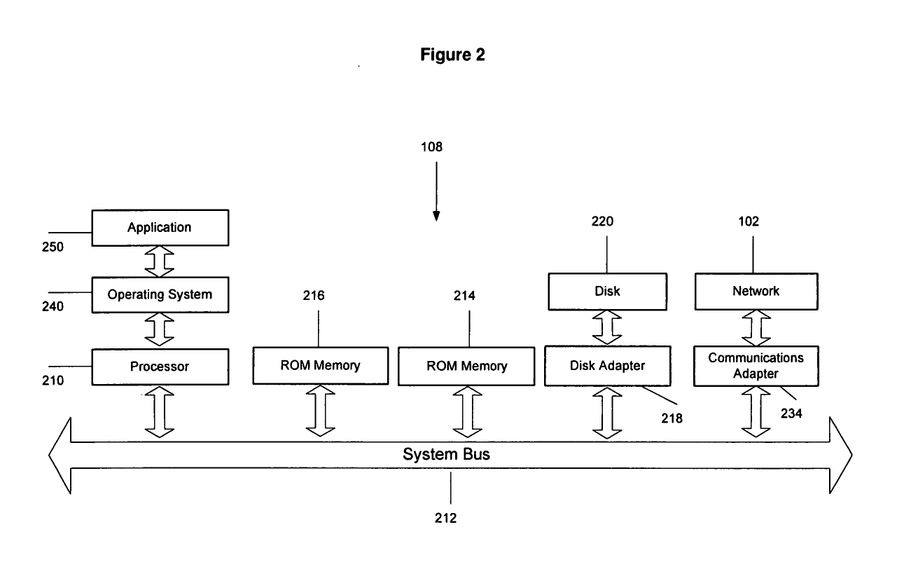

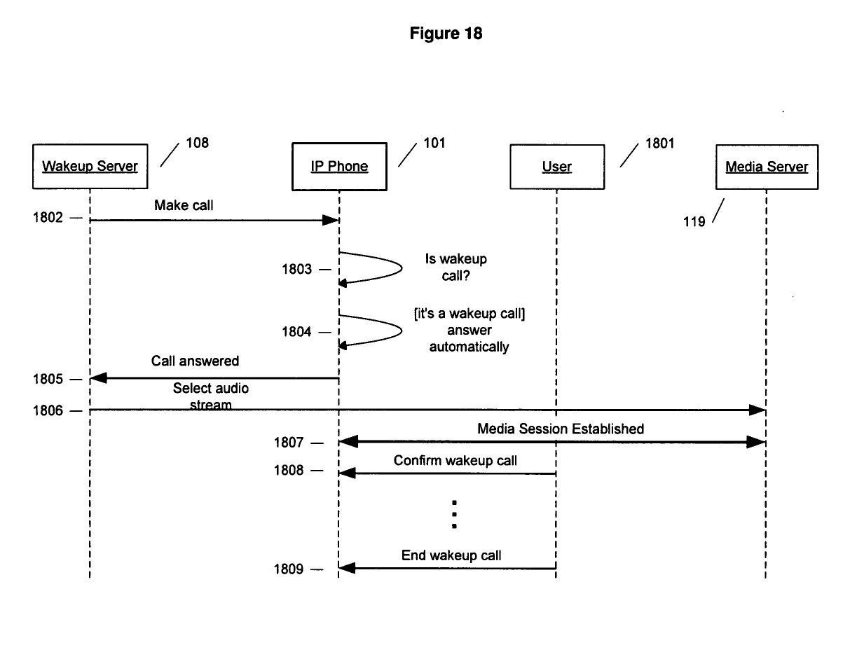

FIG. 2 illustrates a typical hardware configuration of server 108 (FIG. 1) which is representative of a hardware environment for practicing the present invention including performing the steps performed by server 108 described below in connection with FIGS. 18-43. Referring to FIG. 2, server 108 may have a processor 210 coupled to various other components by a system bus 212. An operating system 240, may run on processor 210 and provide control and coordinate the functions of the various components of FIG. 2. An application 250 in accordance with the principles of the present invention may run in conjunction with operating system 240 and provide calls to operating system 240 where the calls implement the various functions or services to be performed by application 250. Application 250 may include, for example, a program for performing the steps performed by server 108 as described below for various enhanced services described in connection with FIGS. 18-43.

Read only memory (ROM) 216 may be coupled to system bus 212 and include a basic input/output system (“BIOS”) that controls certain basic functions of server 108. Random access memory (RAM) 214 and disk adapter 218 may also be coupled to system bus 212. It should be noted that software components including operating system 240 and application 250 may be loaded into RAM 214 which may be server's 108 main memory. Disk adapter 218 may be an integrated drive electronics (“IDE”) adapter that communicates with a disk unit 220, e.g., disk drive. It is noted that the application for performing the steps performed by server 108 as described above in connection with FIGS. 18-43 may reside in disk unit 220 or in application 250.

Referring to FIG. 2, communications adapter 223 may also be coupled to system bus 212. Communications adapter 223 may interconnect bus 212 with an outside network 102 enabling server 108 to communicate with IP phone 101.

Implementations of the present invention include implementations as a computer system programmed to execute the method or methods described herein, and as a computer program product. According to the computer system implementations, sets of instructions for executing the method or methods may be resident in the random access memory 214 of one or more computer systems configured generally as described above. Until required by server 108, the set of instructions may be stored as a computer program product in another computer memory, for example, in disk drive 220 (which may include a removable memory such as an optical disk or floppy disk for eventual use in disk drive 220). Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 3 illustrates an embodiment of an element of the present invention of an external configuration of IP phone 101. Referring to FIG. 3, IP phone 101 includes a touch screen display 301 with the capability of displaying graphical images and collecting input from the user by pressing certain areas in the screen with a finger or an instrument designed for such purposes such as a stylus. IP phone 101 may further include a message waiting indicator 302 to alert the user that a new message has arrived to the user's inbox. Below touch screen display 301, IP phone 101 includes four directional keys 303A-D (303A configured to move an image displayed on screen 101 up; 303B configured to move an image displayed on screen 101 down; 303C configured to move an image displayed on screen 101 to the left; and 303D configured to move an image displayed on screen 101 to the right); and an OK button 304 to navigate the user interface screens 301 and select items in focus, as an alternative to using the touch screen. To each side of directional keys 303A-D, IP phone 101 includes SEND and END keys 305, 306, respectively. Keys 305, 306 may be used as an alternative to the touch screen to exercise telephony features in graphical user interface 301 such as initiating and finishing a call. In addition, keys 305, 306 can be used to help the user navigate the user interface; for example, using END button 306 to go directly to the home screen or cancel some operation. IP Phone 101 also includes the following connectors distributed along side 313 for external devices: Universal Serial Bus (USB) 314, headset 315, microphone 316, Ethernet switched port for Personal Computer (PC) and Local Area Network (LAN), 317 and 318, respectively, power supply 319, RJ-11 (POTS) connector 320, antenna 321 for support of wireless protocols such as, but not limited to, wireless fidelity (WI-FI) and Zigbee, RS-232 serial port 322, and JTAG connector 323.

IP phone 101 may further include an opening 307 for a phone speaker and a handset cradle 308 for corded or cordless handsets. IP phone 101 may further include a standard telephony keypad array 309 consisting of digits 0 to 9, the star and pound keys. Below keypad 309, IP phone 101 may include a circular key 310 used to activate and deactivate speakerphone 307. At each side of speakerphone key 310, two triangular keys 311A-B may be used to increase (311B) and decrease (311A) the volume of the active audio output: handset, headset, speaker or ringer. Below speakerphone and volume keys 310, 311A-B, respectively, IP phone 101 includes an indicator 312 that turns on when speakerphone 307 is active and turns off when speakerphone 307 is inactive.

An embodiment of the hardware configuration of IP phone 101 is provided below in association with FIG. 4. Referring to FIG. 4, IP phone 101 may include a processor 401 coupled to various other components by system bus 413. An operating system 410 may run on processor 401 and provide control and coordinate the functions of the various components of FIG. 4. An application 411 in accordance with the principles of the present invention may run in conjunction with operating system 410 and provide algorithms, domain-specific knowledge and calls to operating system 410 where the algorithms, domain-specific knowledge and calls implement the various functions or services to be performed by application 411. Application 411 may include, for example, an application configured to perform wake-up call transactions, phone directory searches, information and content retrieval, and enhanced call-control functions. Application 411 may include other applications to perform the steps performed by IP phone 101 as discussed further below.

Read only memory (ROM) 402 may be coupled to system bus 413 and could include a basic input/output system (“BIOS”) that controls certain basic functions of IP phone 101. Persistent memory (“FLASH”) 412 may be coupled to system bus 413 and include the operating system 410, configuration data and user data. It is further noted that one or more applications 411 may reside in FLASH 412. Random access memory (RAM) 409 and disk adapter 407 may also be coupled to system bus 413. It should be noted that software components including operating system 410 and application 411 may be loaded into RAM 409 which may be IP phone's 101 main memory. Disk adapter 407 may be an integrated drive electronics (“IDE”) adapter that communicates with a disk unit 408, e.g., disk drive. It is noted that the applications mentioned above may reside in disk unit 408.

Returning to FIG. 4, in conjunction with FIG. 1, communications adapter 405 may also be coupled to system bus 413. Communications adapter 405 may interconnect bus 413 with an outside network 404 enabling IP phone 101 to communicate with data network 102, servers 107, 108, 109, 110, 118, 119, analog phones 113 via PSTN 105, mobile phone 115 via mobile network 114, etc.

Returning to FIG. 4, in conjunction with FIG. 3, other devices 403 may be integrated into the system bus 413 via miscellaneous input/output (I/O) ports 406.

Implementations of the invention include embodiments as a VoIP phone (IP phone) programmed to execute the method or methods described herein, and as a computer program product. According to the implementations, sets of instructions for executing the method or methods may be resident in the random access memory 409 of one or more systems configured generally as described above. Until required by IP phone 101, the set of instructions may be stored as a computer program product in another computer memory, for example, in disk unit 408. Furthermore, the computer program product may also be stored at another computer and transmitted when desired to the IP phone 101 by a network or by an external network 404 such as the Internet. One skilled in the art would appreciate that the physical storage of the sets of instructions physically changes the medium upon which it is stored so that the medium carries computer readable information. The change may be electrical, magnetic, chemical or some other physical change.

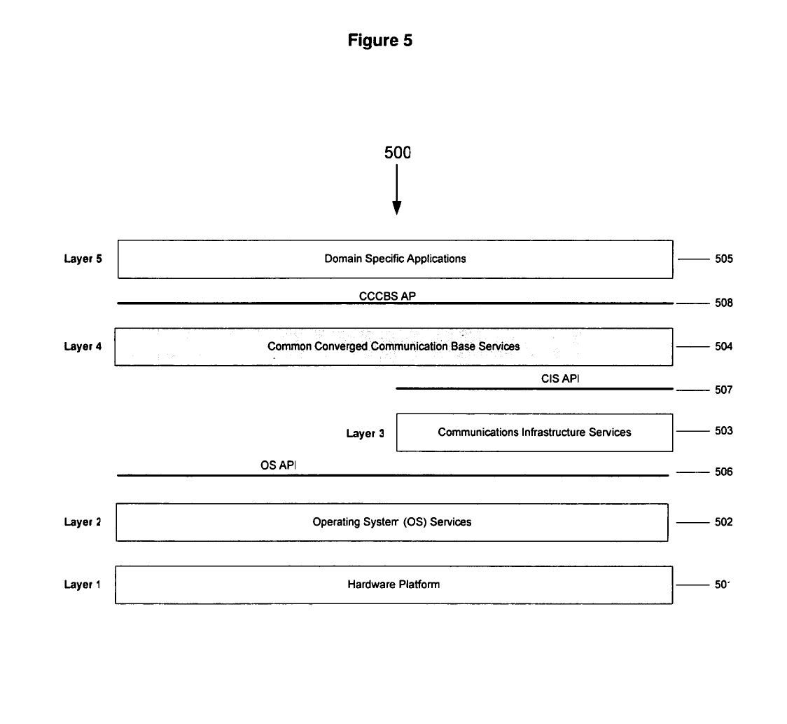

IP phone 101 includes a software platform with multiple layers adaptable to be used with different applications operating on IP phone 101 as well as adaptable to using different communication infrastructures. An embodiment of such a software platform is provided below in association with FIG. 5.

Referring to FIG. 5, platform 500 of IP phone 101 may include five layers. Layer 1 (hardware platform) 501 of platform 500 may include software to control the physical embodiment of IP phone 101. The physical embodiment includes, but is not limited to, Application-Specific Integrated Circuits (ASICs), processing elements, Input/Output (I/O) devices, peripherals, and storage elements.

Layer 2 (operating system services) 502 of platform 500 provides an interface to access operating system (OS) services and hardware platform devices. Layer 2 502 provides an execution environment for the software modules and a hardware abstraction layer. Among the responsibilities of layer 2 502 include implementing common OS services such as memory management, task management, date and time information, and access to peripherals; providing file system services to emulate hard disk drive on flash memory devices; providing a Transport Control Protocol/Internet Protocol (TCP/IP) networking API and the implementation of other required protocols such as Dynamic Host Configuration Protocol (DHCP), Trivial File Transfer Protocol (TFTP), Simple Network Time Protocol (SNTP) and Simple Network Management Protocol (SNMP); providing an embedded web server implementation that allows remote configuration through a web browser; implementing core graphics functionality for drawing, window management, event routing, fonts and bitmaps; and, implementing hardware drivers for each of the converged communication terminal's 101 peripherals.

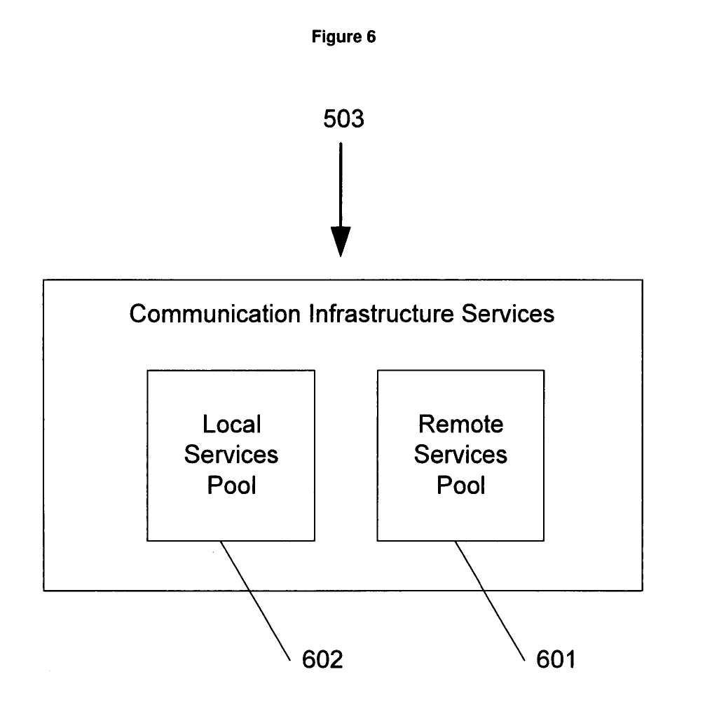

Layer 3 (communications infrastructure services) 503 of platform 500 may be configured to interface with multiple communication infrastructures. Layer 3 503 of platform 500 contains a local services pool and a remote services pool, as illustrated in FIG. 6. It is important to note that system 100 (FIG. 1) contains a basic set of telephony features provided by a Common Converged Communication Base Services (CCCBS) layer 504, as discussed below, which makes server-less communications straightforward as there is no reliance on the server/proxy for such features.

FIG. 6 illustrates an embodiment of the present invention of layer 3 503. Referring to FIG. 6, in conjunction with FIGS. 1 and 5, layer 3 503 may include a remote services pool 601. Remote services pool 601 refers to components that do not reside locally on IP phone 101, but rather on telephony services 109 or PSTN 105 with which IP phone 101 may have to collaborate to provide extended communications features and converged voice/data/video services and/or interface with proprietary IP PBXs 107, application servers 108 and PSTN elements such as centrex, call managers and softswitches. For every specific external collaborating entity, there might be an adapter module that implements all or part of the functionality exposed by a Communication Infrastructure Services (CIS) API 507, as discussed below.

Layer 3 503 may further include a local services pool 602. Local services pool 602 refers to components that reside on IP phone 101 and can provide an interface to communicate and collaborate with proprietary IP PBXs 107, application servers 108 and PSTN 105 elements such as centrex, call managers and softswitches. While the vendor-specific interface implementation could reside locally or remotely on a network server or switch, the advantage of implementing this component on a network server or switch and leaving locally only a proxy to those services is that the need to create a new converged communications terminal 101 image for each change in an external component may be avoided. In addition, the gateway implementation may not be constrained by the (possibly) limited IP phone 101 resources.

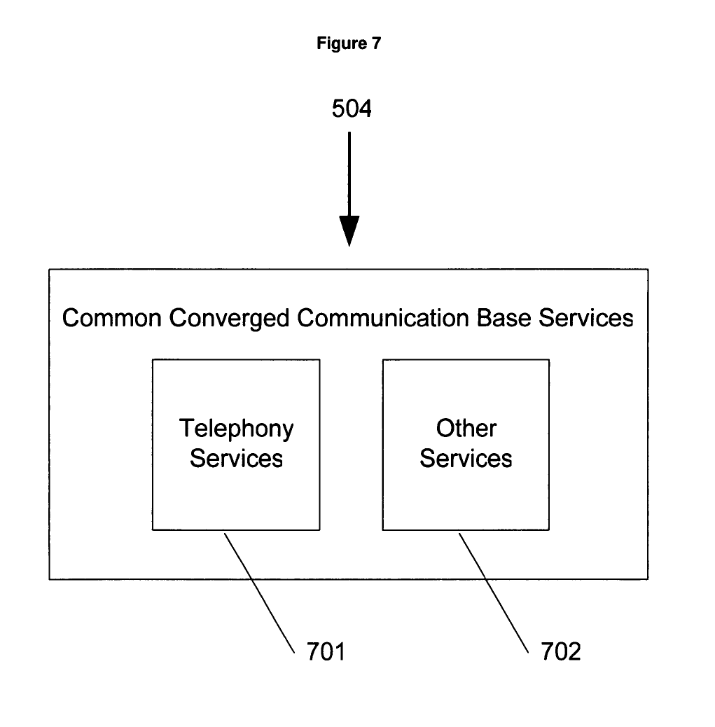

Returning to FIG. 5, platform 500 includes a layer 4 (common converged communications base services) 504. Layer 4 504 includes communications (telephony) specific services as well as other data services that may be required by domain-specific converged communication applications (referring to applications operating on IP phone 101), as illustrated in FIG. 7.

FIG. 7 illustrates an embodiment of the present invention of layer 4 504. Referring to FIG. 7, layer 4 504 includes telephony services 701. Telephony services 701 include call processing functions that implement the core functionality to initiate, terminate and manage phone calls over VoIP and/or POTS communication infrastructures. Layer 4 504 may further include an implementation of signaling, media transport, voice processing and call control functionality. Among the responsibilities of these functions are: providing basic call control features; providing call setup and tear down functionality through protocols like Session Initiation Protocol (SIP), H.323, Media Gateway Control Protocol (MGCP) and others; providing media transport and signaling through protocols like Real-Time Protocol (RTP) and Real-Time Control Protocol (RTCP); providing voice processing features (echo cancellation, Voice Activity Detection (VAD), jitter buffering, etc); and notifying call-related events to the upper layer.

Layer 4 504 may further include other services 702, such as data services. Services 702 may include Hyper-Text Transfer Protocol (HTTP) clients, Remote Procedure Call/Simple Object Access Protocol (RPC/SOAP), extensible Markup Language (XML) parser, directory services, configuration, Personal Computer/ Personal Data Assistant (PC/PDA) synchronization, and user interface. HTTP client services provide a transport protocol to store and retrieve from server objects such as XML documents and images and play an important role in IP communications and application development, therefore enabling converged communications terminal 101 to participate in web-centric architectures. RPC/SOAP services, implement an interface to make remote procedure calls. Remote procedure calls allow IP phone 101 to send requests to and receive responses from components in the computer network. SOAP is an implementation of RPC that uses XML to format request/response information and HTTP to transport this information. Providing support for SOAP enables IP phone 101 to participate in web services. XML parser services translate data represented in XML format into internal data structures and requests for services. Structuring documents using XML allows sharing of information between different platforms and applications. In IP phone 101 there are at least three applications for XML: to describe the user interface layout and components, to make remote procedure calls and to format configuration files. Light-weight Directory Access Protocol (LDAP) provides an interface to access information in directory servers. Directory services are commonly used to carry out three main requirements of Internet Protocol (IP) telephony: authentication, personalization and white pages. Configuration services allow for the management of IP phone 101 settings such as: device ID, network, dial-plans, audio (codecs, Dual Tone Multi-Frequency (DTMF), voice processing), call control, SIP related parameters, volume, display, date/time, authentication, security, voice mail, phone book, ringer behavior, power management, language, peripherals, and software management. These services also implement routines for automatic retrieval of phone configuration and software upgrades from a server. PC and PDA communications services provide an interface to communicate and collaborate with external user devices such as the PC and PDA. IP phone 101 should collaborate closely with these devices to share information, keep that information synchronized, and accomplish tasks more effectively.

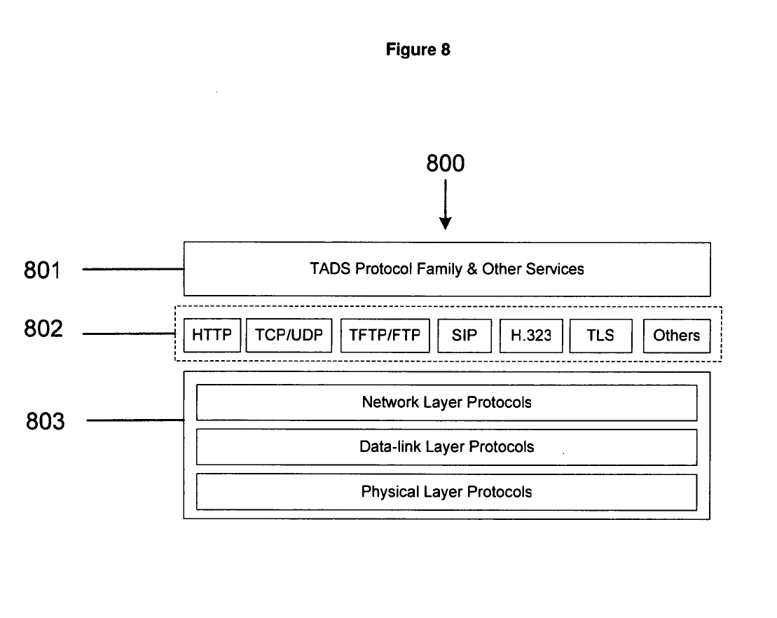

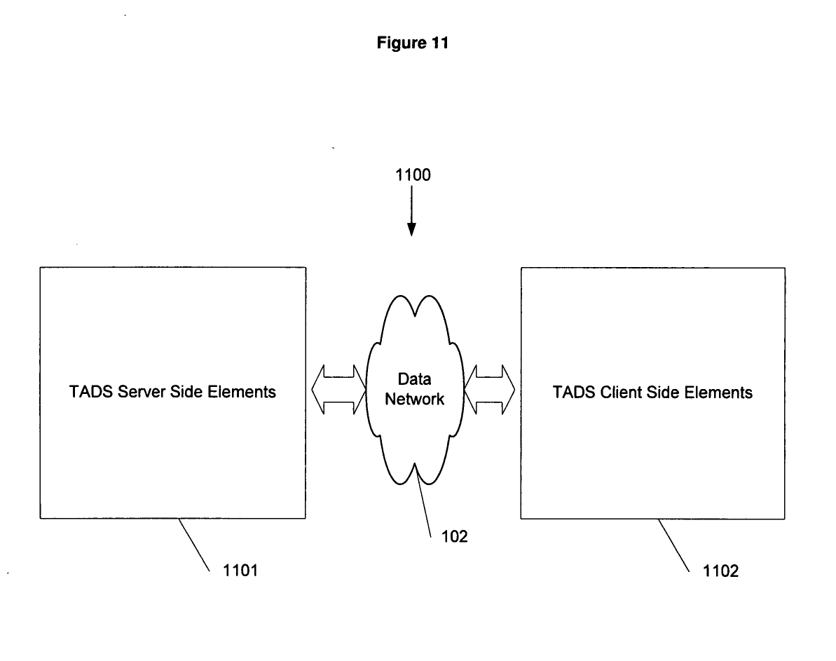

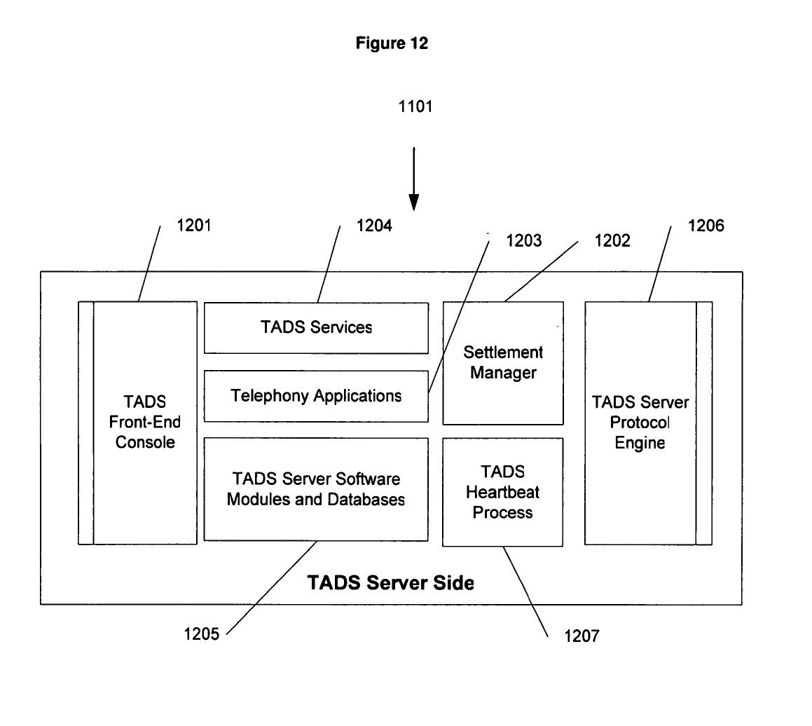

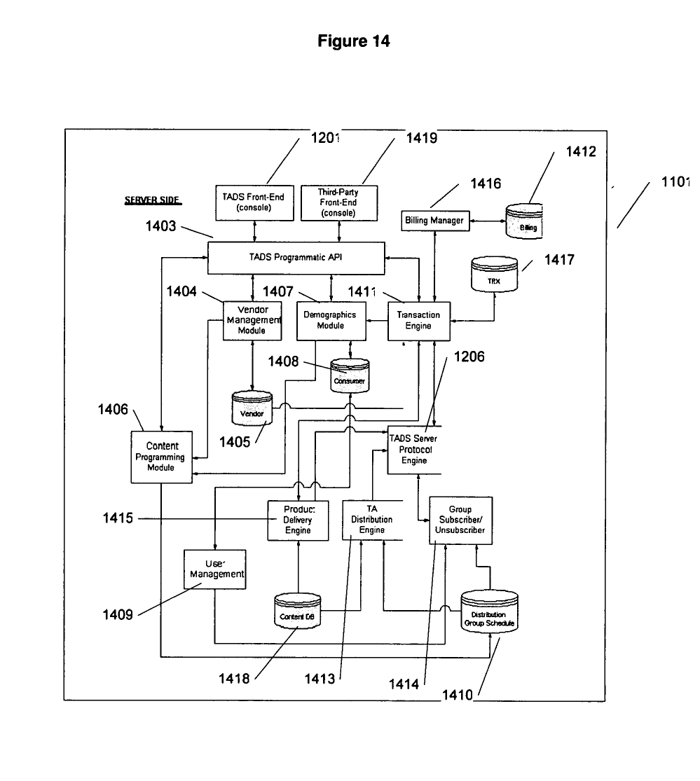

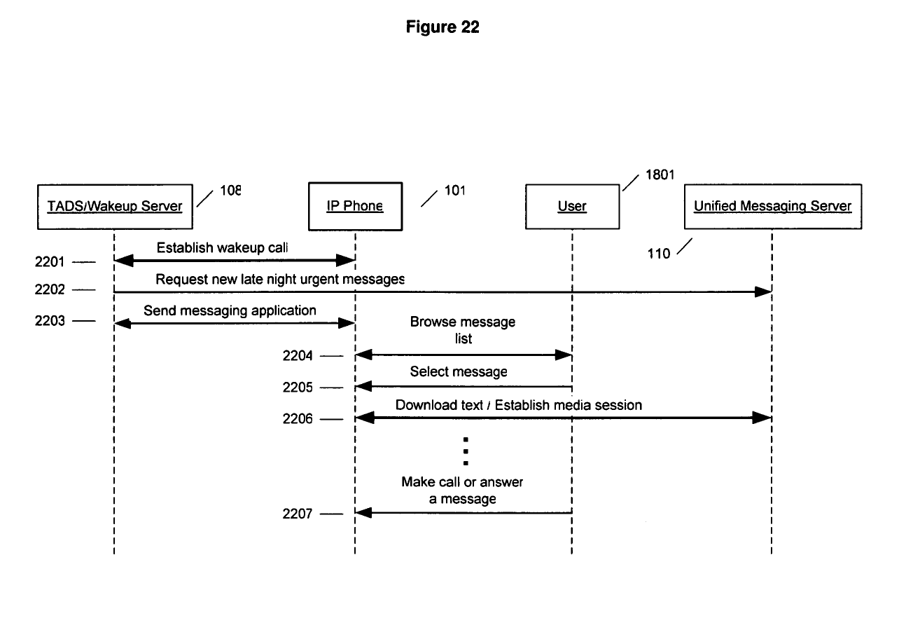

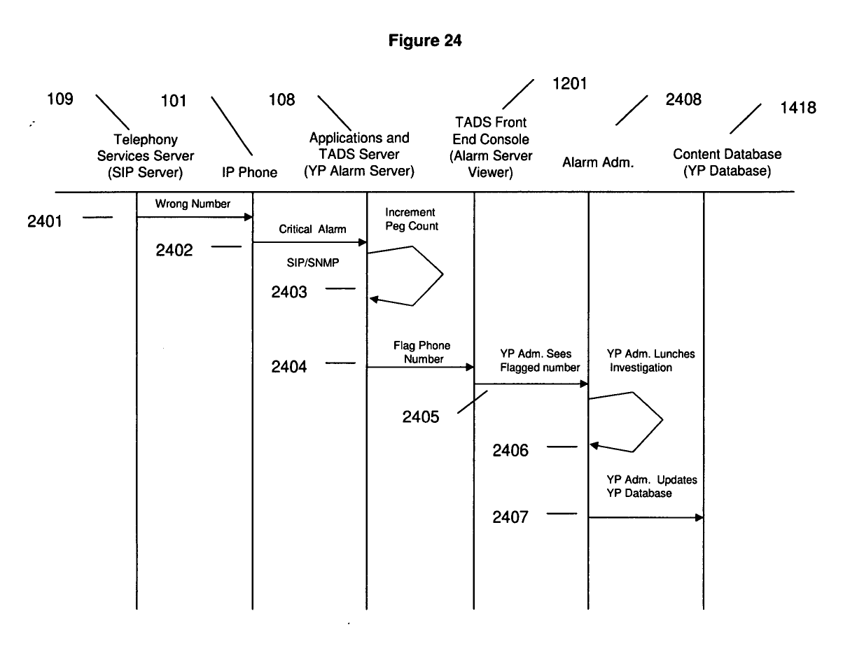

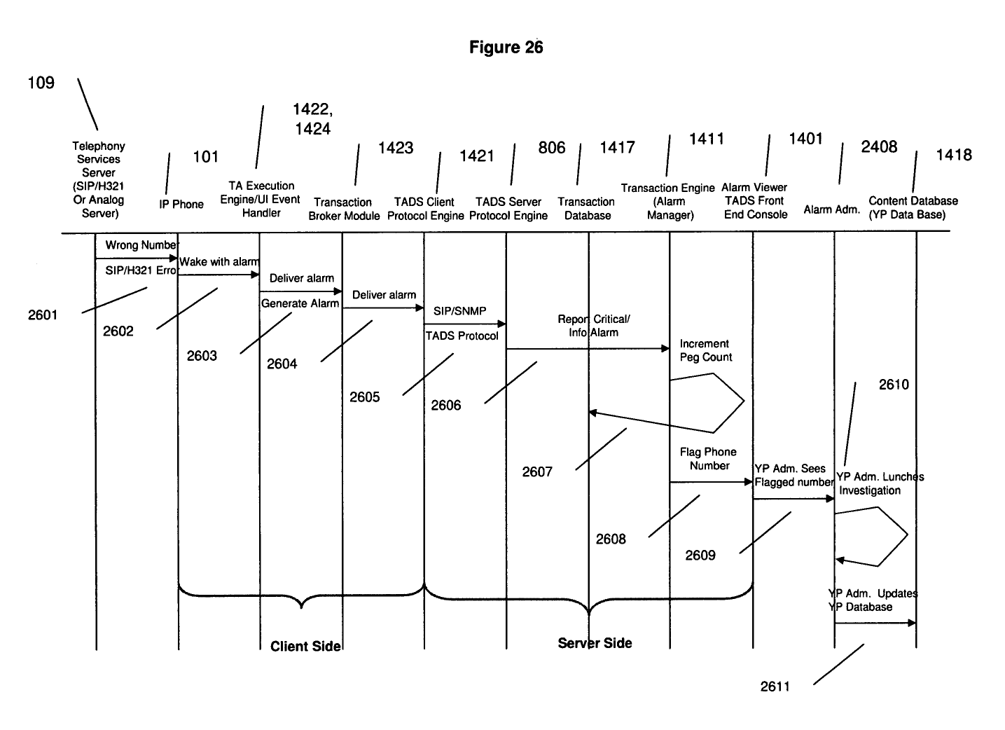

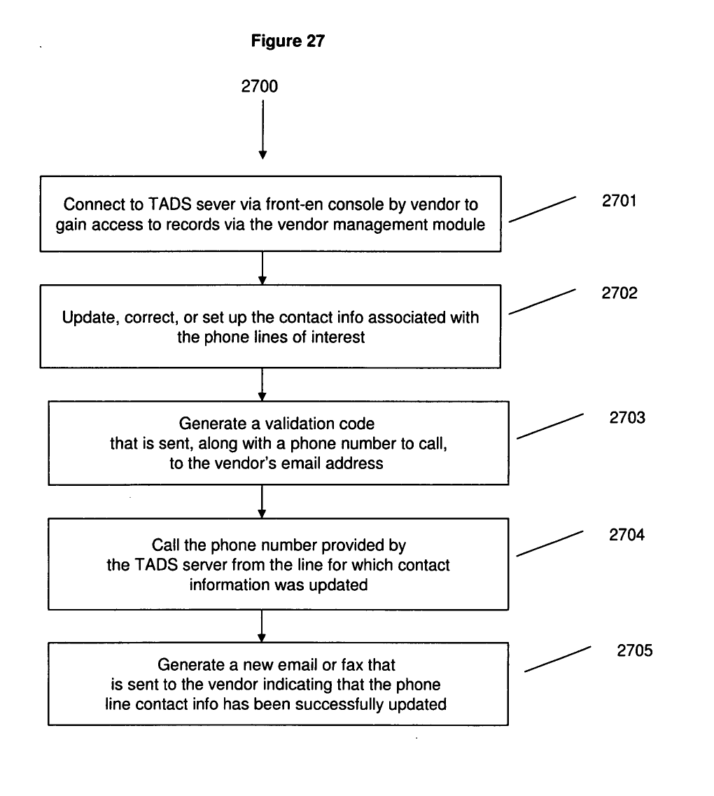

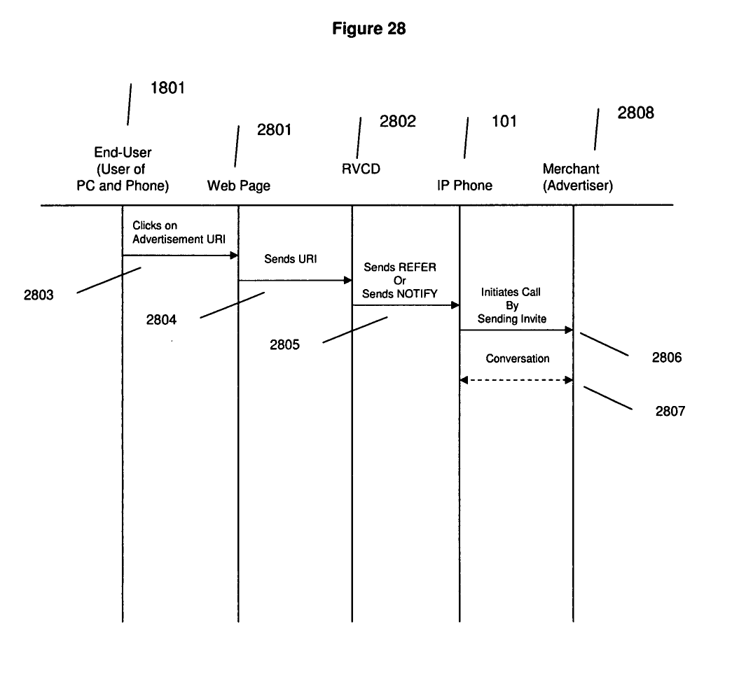

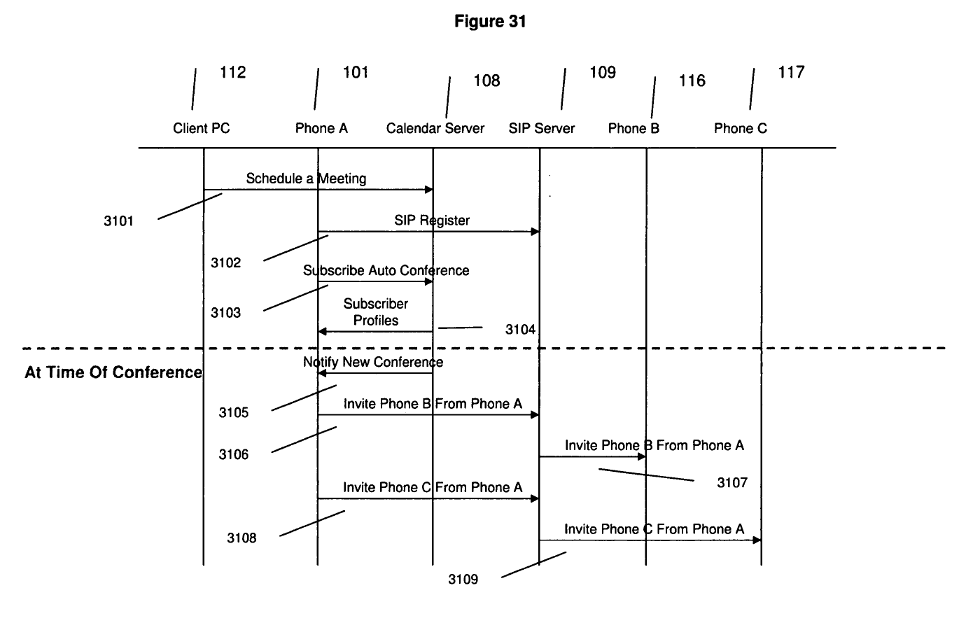

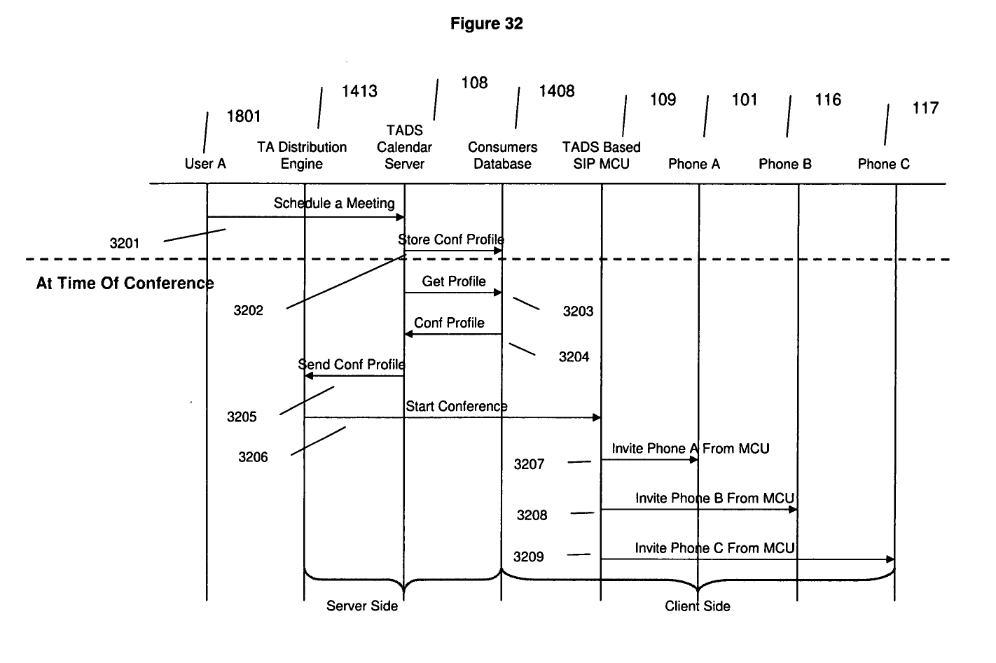

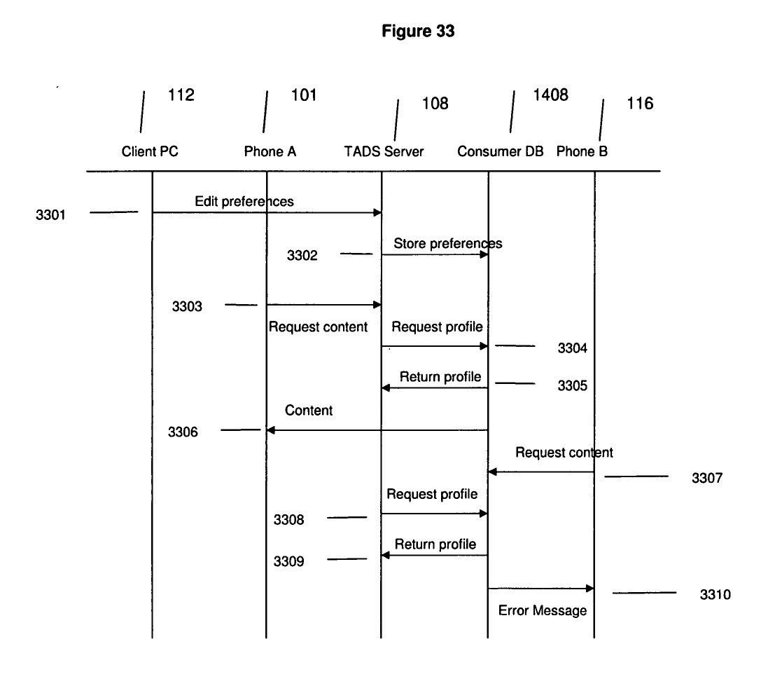

FIG. 8 illustrates the relationship between open-standard protocols 802 above the physical, data-link, and network layers 803 and the TADS protocol family and services 801 in accordance with an embodiment of the present invention. TADS protocol family and services 801 use open-standard communication protocols to exchange information with similar software components in other TADS-enabled devices. New protocols and services can be added to the existing pool by defining protocol and service types. These types are used by the TADS Client Protocol Engine 1101 (discussed below in connection with FIG. 11) and TADS Server Protocol Engine 1006 (discussed below in connection with FIG. 12) to direct TADS messages to their appropriate destination within a TADS-enabled client 1102 (discussed below in connection with FIG. 11) or one of the TADS servers depicted in FIG. 1. Each protocol or service defines its own message format and message sequence required to engage in providing or requesting such service. Examples of these services include, but are not limited to: enhanced wake-up services (provided by TADS Wakeup Call Server 108) (FIGS. 14-21), enhanced data integrity methods (provided by TADS/YellowPages alarm server 108) (FIGS. 22-25), enhanced merchant-customer interaction method (provided by RVCD 2402 (discussed in connection with FIG. 24) in collaboration with IP phone 101) (FIGS. 26-27), enhanced auto-conference methods (provided by SIP Server 109, TADS Calendar Server 108, Consumers Database 1208 (discussed in connection with FIG. 12) in collaboration with IP phones 101) (FIGS. 28-30), enhanced usage control methods (provided by TDS Server 108 and Consumer DB 1208 (discussed in connection with FIG. 12) in collaboration with IP phones 101) (FIGS. 31-32), and enhanced user experience methods provided by TA Distribution Engine 109 (discussed in connection with FIG. 12) in collaboration with IP phones 101) (FIGS. 33-41). Each of these services represents an embodiment of the current invention and contributes towards providing all services the TADS platform advertises.

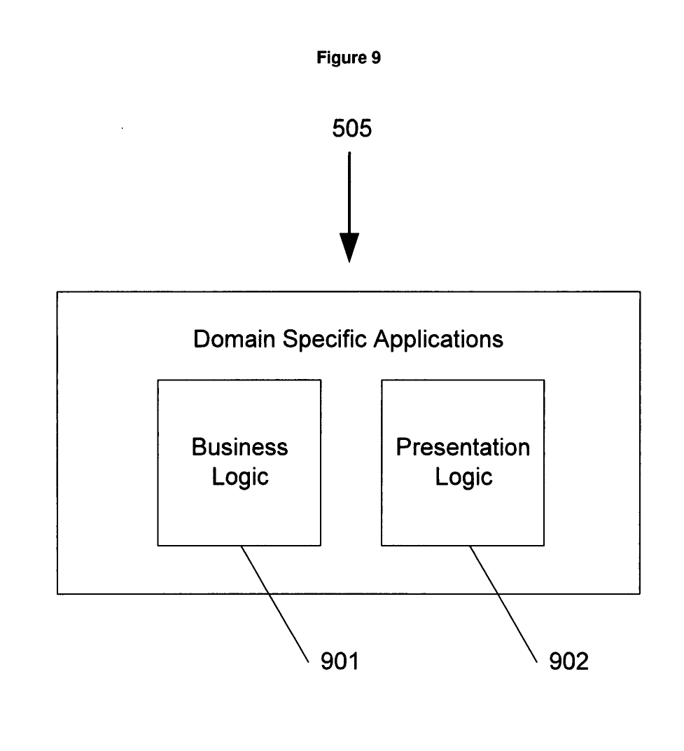

Returning to FIG. 5, platform 500 includes a layer 5 (domain-specific applications) 505. Layer 5 505 implements the business logic and the presentation logic used to run applications operating on IP phone 101 as illustrated in FIG. 9.

FIG. 9 illustrates an embodiment of an element of the present invention of layer 5 505. Referring to FIG. 9, layer 5 505 includes business logic 901 that provides the mechanisms to combine the services provided by underlying modules into coherent applications that add some value to the end user. Some components of business logic 901 may run locally on IP phone 101 and some components will run remotely in an application server 108 (FIG. 1). Some examples include extended calling features, phone directories, management and diagnostic tools, unified messaging, intelligent call management, instant messaging, contact management, personalized ring tones, call tracking, remote collaboration tools, and industry specific applications. It is at this layer that domain-specific differentiating features are implemented.

Layer 5 505 further includes presentation logic 1102 that responds to the fact that the primary concerns of the User Interface (UI) module are the mechanisms of user interaction and how to lay out an appropriate presentation to the user in contrast with the primary concerns of business logic 901 are application domain policies and persistent storage interactions. The UI module may change according to customer's needs without changing the applications core functionality. For example, the same application domain modules with rich, web-based or text-based clients could be reused. Furthermore, the application module can be tested independently without resorting to awkward Graphical User Interface (GUI) scripting tools.

Returning to FIG. 5, layer 4 504 may be leveraged in the design of differentiated IP phones 101 via the following APIs. An operating system services API 506 provides common methods to access services provided by the operating system. For each specific operating system there is a module that supports the abstraction.

A Communication Infrastructure Services (CIS) API 507 provides common methods to access converged communication services available via the installed infrastructure. For each vendor-specific infrastructure there will be a module that will support the abstraction.

A Common Converged Communication Base Services (CCCBS) API 508 provides a standard method to access common converged communication services previously developed to satisfy a broad-range of converged communication domain-specific applications.

Platform 500 may be used to develop domain-specific applications (specific applications operating on IP phone 101) for converged communication devices, to retarget one or more domain-specific applications developed for a specific IP phone 101 to a new hardware platform and/or operating system and/or communications infrastructure.

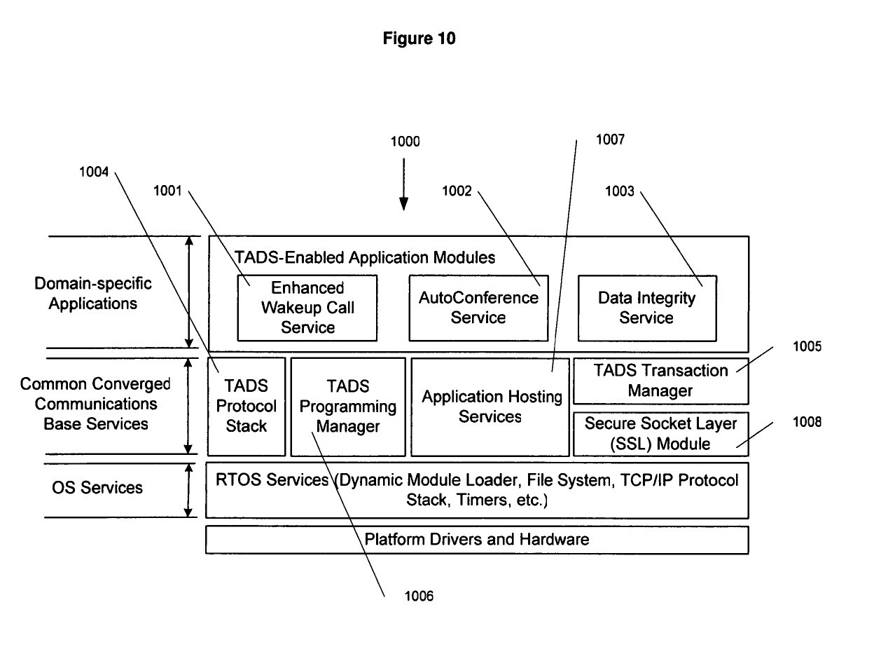

FIG. 10 illustrates an embodiment of the present invention of an application hosting services (“AHS”) architecture 1000 using software platform 500 (FIG. 5) in IP phone 101. AHS architecture 1000 may be used to facilitate the management of third-party applications operating on platform 500 (FIG. 5) of IP phone 101. This includes, but is not limited to: searching for suitable applications on the web, downloading host-able applications to the target, loading and running applications on the target, and security and protection mechanisms to protect other code and data on the target from malicious applications.

FIG. 10 further illustrates an embodiment of the present invention of how transaction applications (TAs) in layer 5 (domain-specific applications) 505 are supported by software modules in layer 4 (CCCBS) 504 of software platform 500 in IP phone 101. Please find presented three examples of domain-specific hosted applications as examples, namely: enhanced wakeup call service 1001, autoconference service 1002 and data integrity service 1003. Enhanced Wakeup Call Service 1001 is a series of services that allow users to setup profiles that will allow a TADS server 108 to, among other capabilities, adjust wakeup call times to account for real-time traffic and weather conditions and user calendar events. Autoconference service 1002 allows users to schedule and subscribe to conference calls that would then be automatically initiated without user intervention. Data integrity service 1003 allows commercial directory services (e.g., yellowpages) to be automatically monitored for erroneous listings due to disconnected numbers, moved numbers, wrong numbers, etc. All three types of applications 1001-1003 can generate transactions, voice calls and other events that can be used to augment user profiles.

A TADS protocol stack 1004 in CCCBS layer 504 implements the communication protocols needed to distribute TAs, carry out transactions, and gather TA events. A TADS transaction manager 1005 in CCCBS layer 504 uses TADS protocol stack 1004 to carry out transactions with another transaction manager at TADS server 1201. A TADS programming manager 1006 in CCCBS layer 504 receives and manages programming information from TADS server 1201 to schedule sponsored programming and other advertisements. Application Hosting Services (AHS) 1007 provide the environment needed by third-party applications in layer 5 505 to run. A Secure Sockets Layer (SSL) module 1008 in CCCBS layer 504 provides secure transport of information between nodes of the network.

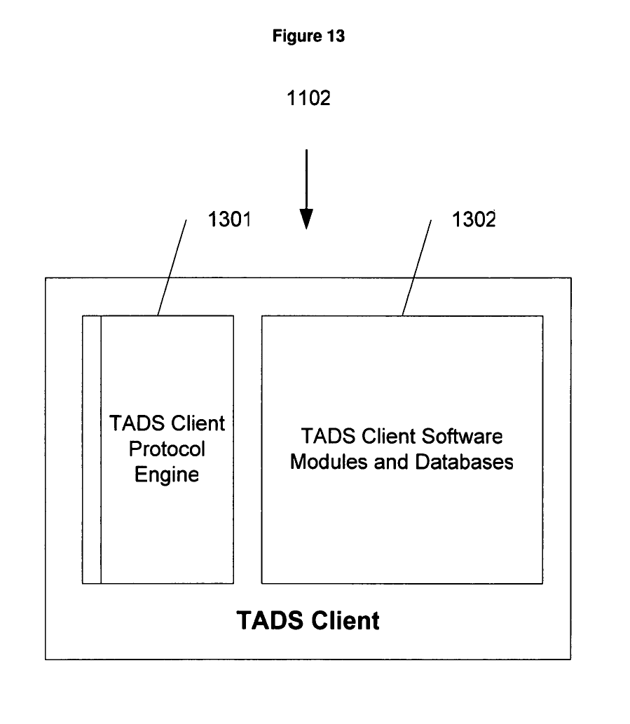

TADS client 1302 (discussed further below in connection with FIG. 13) services can be shared by applications targeted for a broad range of domains, therefore reusing the code that provides the services and effectively shortening the development cycle of domain-specific applications.

Application hosting services architecture 1000 may further include RTOS services 1009 in operating system services layer 502 which is interfaced with platform drivers and hardware 1010.

An embodiment of a client-server communications architecture for which software platform 500 (FIG. 5) and methods that can be used to develop client converged communication terminal devices 101 that can support the distribution of value-added services to end-users is illustrated in FIG. 11.

Referring to FIG. 11, client-services communications architecture 1100 forms the basis of a Transactional Application Delivery System (TADS) for service providers and/or third party developers and content providers to rapidly develop, deliver, and manage revenue generating and productivity enhancing data-voice applications for IP phones 101. Data-voice applications are those that take advantage of voice over Internet Protocol (VoIP) and/or POTS/Broadband infrastructures.

As illustrated in FIG. 11, TADS server side elements 1101 communicate with TADS client side elements 1102, e.g., IP phones 101, via data network 102, e.g., Internet. Client-services communications architecture 1100 has built-in flexibility allowing it to evolve with advancements in hardware, software, protocols, thus providing an extensive platform for delivery of applications and content. The following are among the main characteristics of software platform 500 (client-services communications architecture 1100).

TADS 1100 provides an integrated download and content management system which enables the delivery of software and content to enabled devices. This download manager supports the entire process of software provisioning, including the submission of content and applications from third-party developers, testing and certification of those applications, bundling, pricing, demographics-based targeted promotions, and delivery to enabled terminals.

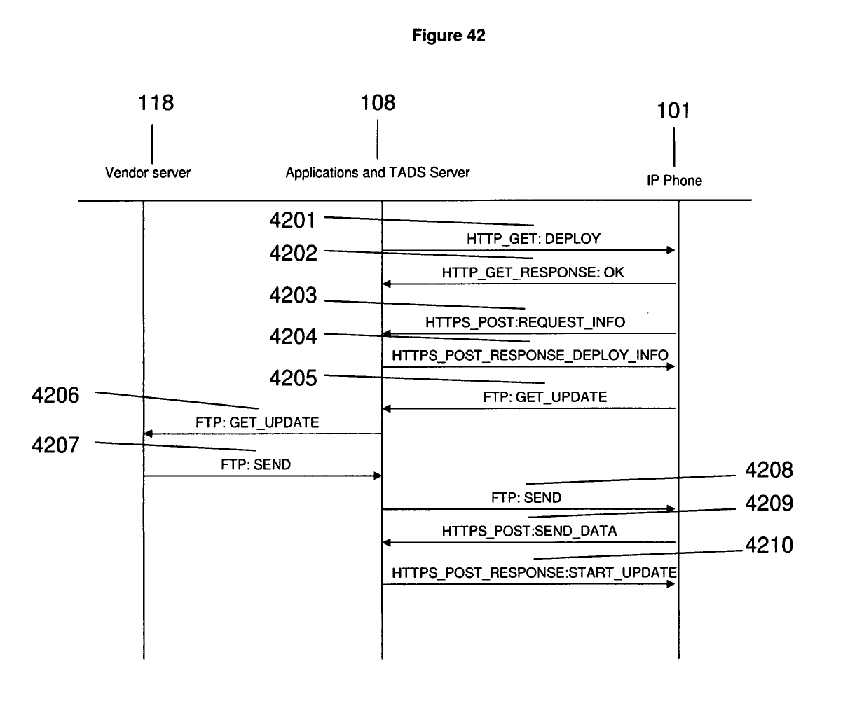

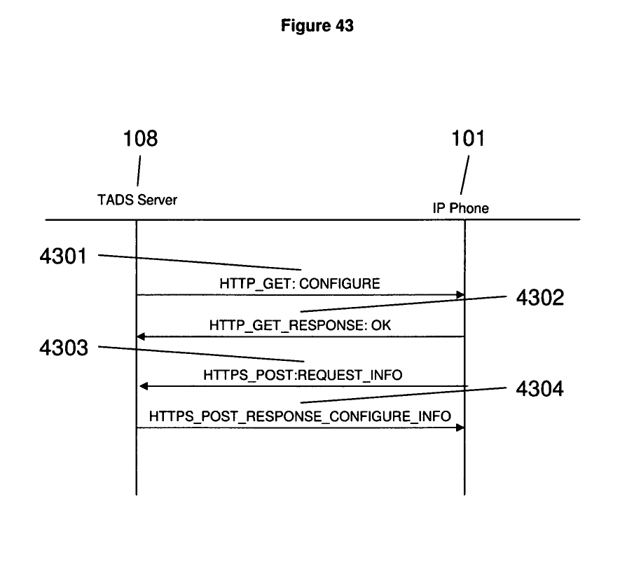

TADS 1100 further includes the capability to remotely, provision, configure, diagnose, or upgrade compatible devices (as described in FIGS. 42-43 below). This enables providing online help support to users and reducing the need for on premise visits. Through this capability, service providers are able to bring up new clients, push the latest software updates to the terminals, or remotely perform a move, add, or change to a customer's system.

TADS servers 1101 may process all voice and data before transmitting to the device. TADS servers 1101 communicate with devices 1102 to determine the optimal delivery, compression, and formatting of the information to be displayed on IP phone 101. This content optimization will maximize the service providers use of available device resources ate at the customer's premise.

TADS 1100 further includes the capability of using open standard interfaces to enable quick and easy integration with a carrier's existing systems and third party equipment and software.

Furthermore, all software components of TADS 1100 incorporate redundancy and load balancing to provide a very high level of service availability. To enable carrier grade reliability, TADS servers 1101 route all voice and data traffic to other servers should it encounter any hardware or software failures. TADS 1100 provides scalability simply through the addition of servers. A more detailed description of TADS 1100 is provided below in association with FIG. 12 and 13.

FIG. 12 illustrates an embodiment of the present invention of the server side of TADS 1100. Referring to FIG. 11, TADS 1100 includes a server side 1101 and a client side 1102. It is noted that TADS server 1101 refers to server 108 (FIG. 1) and that TADS client 1102 refers to IP phone 101 (FIGS. 1 and 3-4).

Referring to FIG. 12, TADS server side elements 1101 include a front-end console 1201 that allows administrators to submit, via a web-based interface (not shown), multi- media content, define the demographic/profile characteristics of the target audience, schedule the dates and times when applications and services should be distributed, and charge for the services if applicable.

TADS server side elements 1101 further include a TADS server protocol engine 1206 that handles all communications using the TADS protocol on the server side for handling transactions, distributing applications and services, subscribing clients to distribution groups and delivering products to clients.

TADS server side elements 1101 further include various server software modules and databases 1205 on top of which telephony applications 1203 and converged voice-data applications and services may be constructed 1204. TADS server side elements 1101 further include a settlement manager 1202 that maintains a log of all end-user actions during a converged communications session that can then be used to determine profit allocation throughout the value chain (merchants, content providers, service providers, and the owner of the content distribution platform) as well as to obtain valuable closed activity reports that may be used to drive new services and log valuable demographic data on all end-user transactions. TADS heartbeat process 1207 informs other TADS-enabled devices about its processor load and other transient data by sending periodic heartbeat messages. A proxy server 120 (FIG. 1) can be used to distribute requests for TADS services among several TADS servers 108 (FIG. 1), content media servers 119 (FIG. 1) and converged messaging and directories servers 110 (FIG. 1) so as to balance the load uniformly throughout all of them or to avoid sending requests to servers that have become unavailable. Unavailable servers are servers for which heartbeat messages have not been received for some configurable period of time. They can be considered to be infinitely loaded with requests for service. The TADS server software modules and databases are described in more detail in FIG. 14, as discussed further below.

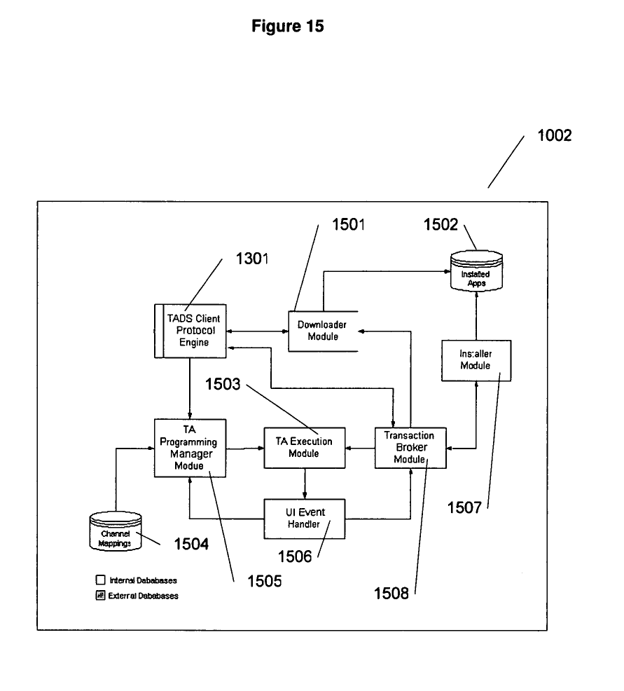

FIG. 13 illustrates an embodiment of the present invention of the client side of TADS 1100. The client side includes the TADS Client Protocol Engine 1301 that handles all communications using the TADS protocol on the client side for handling transactions, executing applications and accessing services. The client side also includes various TADS client software modules 1302 and databases that are described in greater detail in FIG. 15, as discussed further below.

Referring to FIG. 14, TADS front-end (console) 1201 may be configured to be a front-end to the Transactional Applications Delivery System (TADS) programmatic API 1403. TADS front-end (console) 1201 presents a selective view of all the data accessible to programmatic API 1403. This includes custom graphical user interfaces, web-based interfaces, command line interfaces, and others. Customized front-ends can be developed by third-parties also.

TADS programmatic APIs 1403 expose all aspects of the TADS framework to calling applications. This includes browsing (read, write, delete, add) information on consumers, vendors, billing, channel definitions, transactions, content and distribution groups.

TADS server side elements 1101 further include a vendor management module 1404 configured to allow access to a vendor database 1405. Vendor management module 1404 may be an adapter to communicate with an existing system or internal vendor database 1405. All the information regarding vendors is stored and accessed through vendor management module 1404. Vendor management module 1404 can be used by a content programming module 1406 to get vendor information. Vendors buy advertisement space/time on IP phone 101 and get orders from customers through IP phone 101.

TADS server side elements 1101 further include a demographics module 1407 configured to access a consumer database 1408 and apply rules to query records that show specific demographic characteristics. Demographics module 1407 may further include an adapter to communicate with an existing system or an internal consumer database 1408.

TADS server side elements 1101 further include a user management module 1409. Users of TADS-enabled clients may be regarded as consumers by the vendors using TADS. Users can be added, changed or deleted through the use of user management module 1409. All information regarding users is accessed through user management module 1409.

TADS server side elements 1101 further include content programming module 1406, as mentioned above. Content programming module 1406 is involved in defining the distribution and exposition of advertisements throughout the network of TADS-enabled clients, e.g., IP phone 101. Advertisements are exposed at the remote clients by the transactional applications distributed by TADS server 1101. Vendors can use the graphical user interface exposed by TADS front-end 1201 to access content programming module 1406. Content programming module 1406 may be used to create distribution groups for advertisements and to schedule showing time among the clients in the group. Vendors can define distribution and level of exposure for an advertisement using criteria such as user demographics, geographical or organizational boundaries and buying history. The resulting scheduling information is stored in a distribution group schedule database 1410.

TADS server side elements 1101 further include a transaction engine 1411. Transaction engine 1411 is an engine that autonomously handles transactions from TADS clients 1102. Transaction engine 1411 may be configured to keep records of all transactions handled. Transaction engine 1411 may also access a billing database 1412 (or an external billing system). Transaction engine 1411 can also change consumer database 1408 to reflect particular information about consumer buying behavior in consumer database 1408. Transactions are started by clients 1102. A transaction starts with a user selecting a service or application on a TADS-enabled device 1102. Client and server exchange session details and after the request is confirmed the product is delivered (when appropriate) over network 102. A transaction ends when the product is delivered to the TADS-enabled device, e.g., IP phone 101.

TADS server side elements 1101 further include TADS server protocol engine 1206, as mentioned above. TADS server protocol engine 1206 may be configured to handle all communications using the TADS protocol on the server side. The TADS communication protocol is used for handling transactions, distributing advertisements, subscribing clients to distribution groups and delivering products to clients 1102.

TADS server side elements 1101 further include a Transactional Applications (TA) distribution engine 1413. TA distribution engine 1413 may be used to distribute Transactional Applications (TA) to TADS-enabled clients 1102, e.g., IP phones 101. TA distribution engine 1413 may be configured to look up the scheduling database for TAs to distribute and to use TADS protocol engine 1206 to send them to the appropriate destinations. Destinations are defined as groups of TADS-enabled clients 1102 that have been identified as having the appropriate channels to handle the TA to be sent. Transactional applications are chartered with the task of advertising a product and completing a sell transaction from a network of TADS-enabled clients 1102.

Channels of content are created according to needs based on demographics information (managed by the demographics module - 1407, and stored in the consumer DB 1408) and vendor requests (managed by Vendor Management Module 1404 and Vendor DB 1405). Each channel may have different characteristics, including, but not limited to size and position of display (screen “real estate”), content type provided by channel (static or animated images, sound, voice messaging, multimedia (integrated visual and sound elements, even applications, etc.), duration of exposure per event shown (10 sec, 30 sec, 30 min), time and frequency of exposure (“prime time,” “red eye,” “repeat every 10 minutes,” etc.), rule based exposure (“show during calls,” “show when user searches for pizza,” etc.) target demographics (e.g. “shown in luxury suites,” “shown in metro area,” “shown in technical office parks,” etc.), numerical exposure rating (100 TADS enabled devices, 100,000 TADs enabled devices), and device based exposure rating (“TADS enabled phones,” “TADS enabled PCs,” “TADS enabled PDAs”). Based on channel characteristics, vendor profiles and demographics information, the content programming module 1406 can create channels of content distribution. Each channel will have, based on it's characteristics and sales agreements reached with vendors (possibly by auctioning time on channels), costs associated with putting information in the channel. This information will be used by the billing manager 1416 to bill 1412 vendors for time used in the channels. Some channels may have different costs and characteristics at different times of day (“prime time” costs may be larger than “red eye” costs, for example). Also, TADS 1101 could assign different channels to TADS enabled devices based on the TADS enabled devices 1102 group information (managed by the Group Subscriber/Unsubscriber module 1414, and stored in the Distribution Group Schedule 1410).

TADS server side elements 1101 further include a group subscription manager module 1414 configured to handle the subscription and un-subscription of TADS-enabled clients 1102 for each distribution group. A distribution group contains an identifier for each of TADS-enabled clients 1102 that are members of the group. Subscription can take place at client registration time or it can be initiated by the server whenever a TA is scheduled for distribution. The subscription process delivers scheduling information for a TA to TADS-enabled clients 1102.

TADS server side elements 1101 further include a product delivery engine 1415 configured to assist transaction engine 1411 to complete a sale by delivering a product purchased to TADS-enabled client 1102 whenever possible.

TADS server side elements 1101 further include a billing manager module 1416 used to access billing information. Billing manager module 1416 may include an adapter to communicate with an external billing system or internal billing database 1412.

Billing database 1412 may contain information on sales done on behalf of vendors through TADS and TA distribution charges. Vendors are billed by service providers for their use of TADS. It can also handle service-usage billing.

Other databases in TADS server side elements 1101 include a transaction database 1417 configured to contain records of all transactions enabled by TADS.

Another database in TADS server side elements 1101 is vendor database 1405, as mentioned above. Vendor database 1405 contains vendor information.

Another database in TADS server side elements 1101 is consumer database 1408, as mentioned above. Consumer database 1408 contains all information related to consumers. Consumers are the users of TADS-enabled clients 1102.

Another database in TADS server side elements 1101 is distribution group schedule database 1410, as mentioned above. Distribution group schedule database 1410 contains information on what devices should get what TAs and at what times they should be shown.

Another database in TADS server side elements 1101 is a content database 1418. Content database 1418 contains products and TAs to be delivered by TADS server 1101.

Referring to FIG. 15 elements of TADS client 1102 include a TA programming manager module 1505 configured to receive subscription requests from servers through a TADS client Protocol Engine 1301. TA programming manager module 1505 may be configured to keep track of what TAs are expected through each channel at specific times and where in the phone user interface they should be rendered.

TADS Client Protocol Engine 1301 may be configured to handle all communications using the TADS protocol in each client. The TADS communication protocol is used for handling transactions, distributing advertisements, subscribing clients to distribution groups and delivering products to clients 1102.

Client side elements 1102 may further include a TA execution engine 15 configured to execute a TA at the client, e.g., IP phone 101. The TA uses a transaction broker module 1508 to engage in transactions with TADS server 1101. TA execution engine 1503 also renders advertisements on the user interface of the TADS-enabled client 1102, e.g., IP phone 101.

Client side elements 1102 may further include a UI event handler 1506. UI event handler 1506 is not provided by the TADS framework. It is part of the infrastructure of TADS-enabled client 1102. UI event handler 1506 gets events from the UI of TADS-enabled client, e.g., IP phone 101, and forwards them to transaction broker module 1508 and TA execution engine 1503.

Transaction broker module 1508 interacts with transaction engine 1501 at TADS server 1101 through TADS client protocol engine 1101. Transaction broker module 1508 helps TAs to complete transactions.

Client side elements 1102 may further include a product installer module 1507 configured to install products in database 1502 delivered through the TADS framework.

Client side elements 1102 may further include a product downloader module 1501 which interacts with the product delivery engine at TADS server 1101 through TADS client protocol engine 1101. Product downloader module 1501 downloads products purchased through TADS.

Client side elements 1102 may further include a group and channel bindings database 1504 which contains information on what TAs will be delivered through each distribution group and when and where in the UI their advertisements will show up.

Installed applications database 1502, as mentioned above, will hold all applications installed through TADS.

It is noted that the embodiment of the server and client sides of TADS 1100 may include other and/or additional modules that for clarity are not depicted. It is further noted that TADS 1100 may be implemented with a different combination of modules and that those presented in the discussion of FIGS. 12-15 are illustrative.

Additional details regarding the TADS as described above are disclosed in the U.S. patent application, filed on Mar. 17, 2005, entitled “Internet Protocol (IP) Phone with Search and Advertising Capability,” with the Ser. No. 11/082,361, which is hereby incorporated by reference in its entirety.

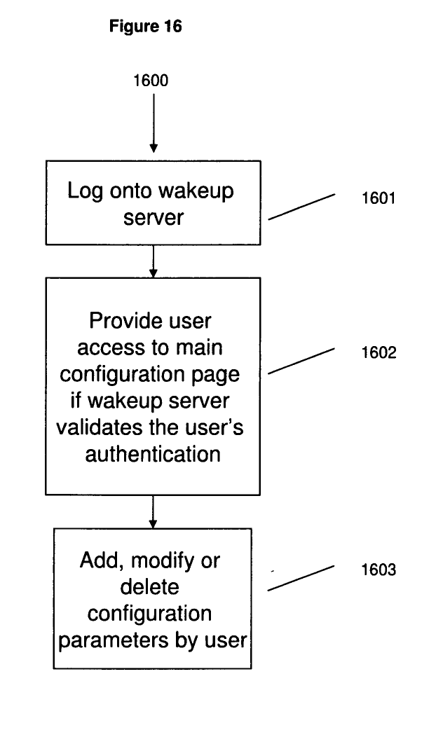

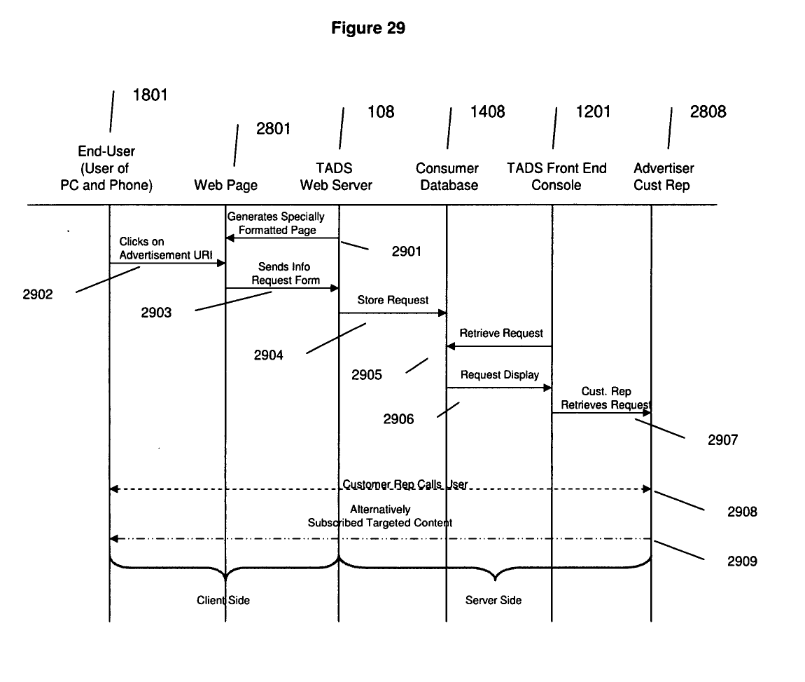

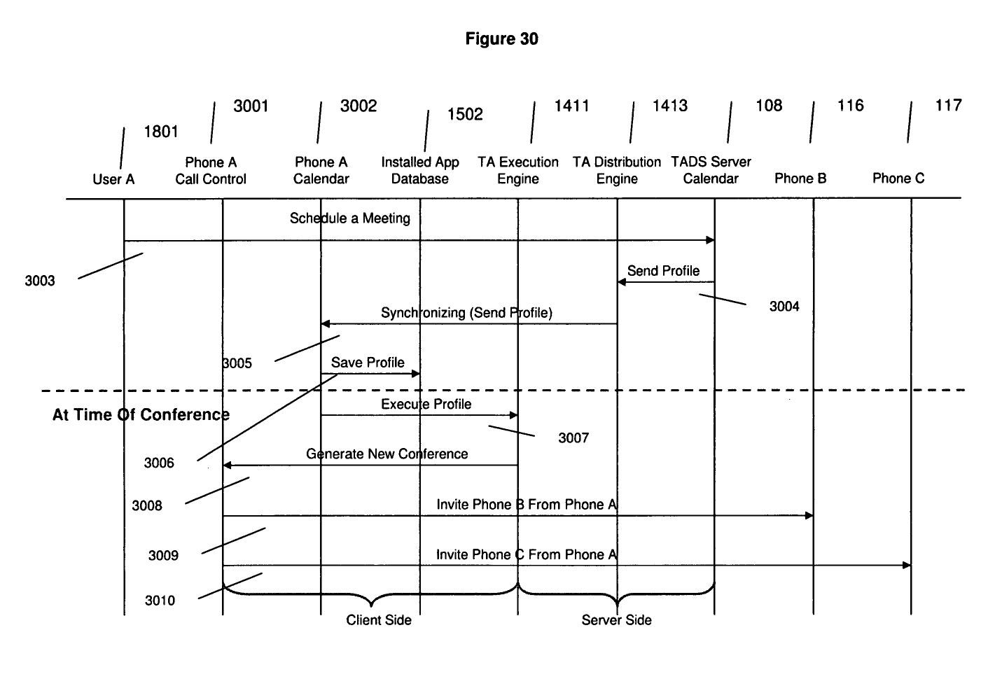

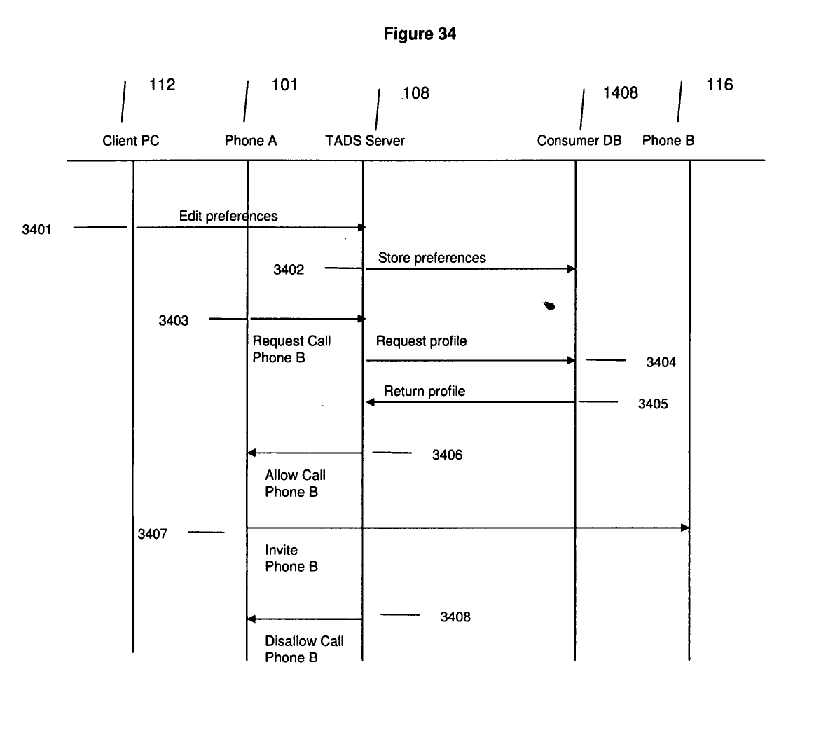

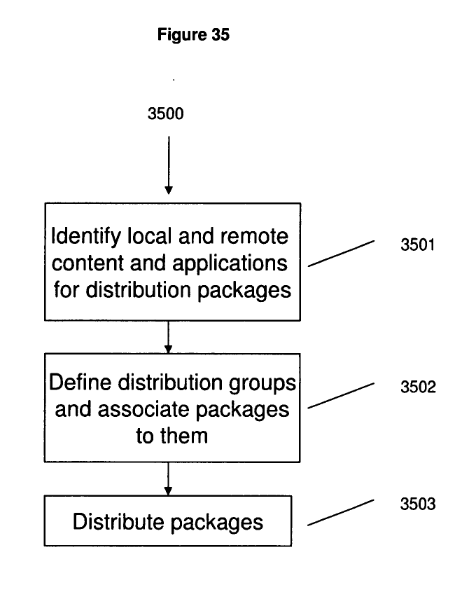

Example services enabled by an embodiment of the present invention, as discussed in conjunction with FIGS. 1 and 11-15, include, but are not limited to: enhanced wake-up services (provided by TADS wakeup call server 108) (FIGS. 16-23), enhanced data integrity methods (provided by TADS/YellowPages alarm server 108) (FIGS. 24-27), enhanced merchant-customer interaction method (provided by Remote VoIP Call Dispatcher (RVCD) 2402 (discussed in connection with FIG. 28) in collaboration with IP phone 101) (FIGS. 28-29), enhanced auto-conference methods (provided by SIP server 109, TADS calendar server 108, consumers database 1208 (discussed in connection with FIG. 12) in collaboration with IP phones 101) (FIGS. 30-32), enhanced usage control methods (provided by TDS server 108 and consumer database 1208 (discussed in connection with FIG. 12) in collaboration with IP phones 101) (FIGS. 33-34), and enhanced user experience methods provided by TA distribution engine 109 (discussed in connection with FIG. 14) in collaboration with IP phones 101) (FIGS. 35-41). Each of these services represents an embodiment of the current invention and contributes towards providing all services the TADS platform advertises.

The following presents a discussion of the exemplary services or applications mentioned above in connection with FIGS. 16-41 that leverage the TADS building blocks discussed in FIGS. 11 - 15 and software platform 500 (FIG. 5). Consequently, each of these Figures, FIGS. 16-41, will be discussed below in connection with FIGS. 1-13.

The TADS Wakeup Call Server (TWCS) 108 controls the service execution and configuration. A vendor server 118, a unified messaging server 110, a content and media server 119 collaborate with the TWCS via a data network 102 to deliver the specific service that the user requests via IP phone 101. IP phone 101 receives the wakeup call and enables all the other enhanced services described in association with FIGS. 16-23.

The enhanced wakeup services depend on the user being able to create and store personal preferences or profiles directly at IP phone terminal 101 or through a configuration portal to wakeup server 108 using a web browser. The configuration sequence is presented in FIG. 16. FIG. 16 is a flowchart of a method 1600 for creating and storing personal preferences or profiles via a configuration portal to wakeup server 108. Referring to FIG. 16 in conjunction with FIG. 1, in step 1601, the user logs on to wakeup server 108. In step 1602, if wakeup server 108 validates the user's authentication credentials, wakeup server 108 provides the user access to a main configuration page. In step 1603, the user adds, modifies or deletes any of the following configuration parameters: wakeup calls, rules for their scheduling (recurrence) and wakeup sound preferences; snoozing patterns: interval between calls, for how long, wakeup sound; task and appointment lists (manually or through synchronization with another server); sources of information feeds and categories of interest: news, weather, sports, travel itineraries. For example, wakeup server 108 can adjust automatically the wakeup call settings based on rules that the user specifies. The input parameters for these rules can be information available on the network or on the user's profile (weather and traffic conditions, early morning appointments, hotel checkout time, travel schedules, etc). Alternatively, wakeup server 108 can suggest to the user the proposed changes to the settings instead of changing them automatically so that the user can verify and approve them. Some specific situations where this can be applied are the following. Wakeup server 108 automatically schedules the wakeup call some time earlier than ordinary due to a sudden traffic jam in my route to work or to the airport. In another example, wakeup server 108 suggests a change in a recurrent wakeup call due to an early morning appointment at work, with the doctor, with mechanic or with friends for a trip. In another example, wakeup server 108 can employ information from the user's travel itinerary to create or suggest wakeup call settings in advance. In another example, wakeup server 108 can look up in the network the estimated time of arrival from the hotel to the airport (considering distance and traffic conditions) and adjust the time accordingly. Wakeup server 108 may even consider the differences in time zones. Vendors can log into the TADS server in the same way as a regular user and can associate and schedule advertisements, services and offers to wakeup calls.

It is noted that method 1600 may include other and/or additional steps that, for clarity, are not depicted. It is further noted that method 1600 may be executed in a different order presented and that the order presented in the discussion of FIG. 16 is illustrative. It is further noted that certain steps in method 1600 may be executed in a substantially simultaneous manner.

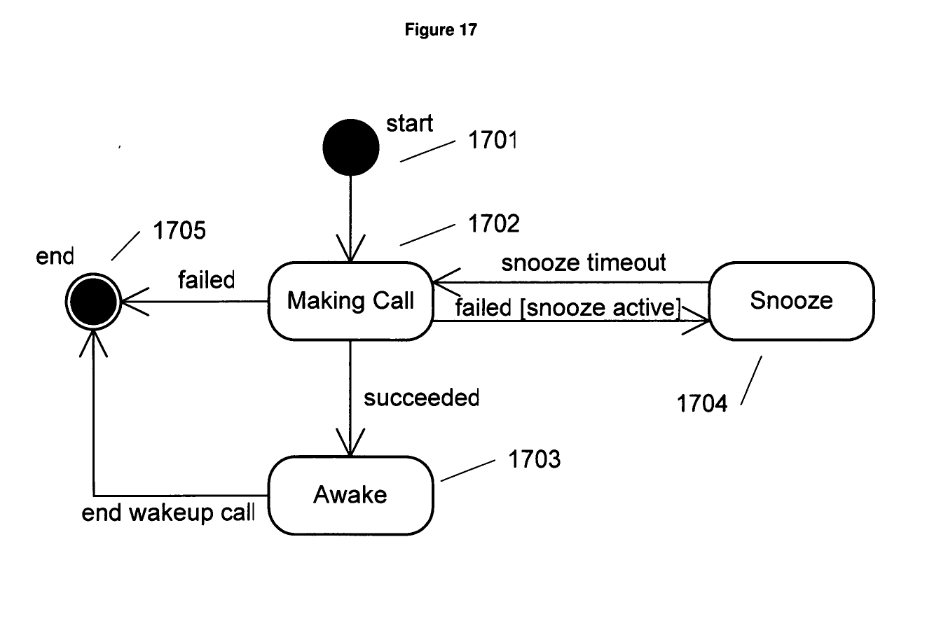

FIG. 17 shows the high-level state machine diagram of the wakeup service in accordance with an embodiment of the present invention. The process is composed of three states: making a call (1702), awake (1703), and snooze (1704). The process begins at a start point (1701) and ends at an end point (1705). The process starts at start point 1701 when wakeup server 108 initiates the call and phone 101 starts ringing or answers the call automatically. If the user confirms the wakeup call, i.e. indicates wakeup server 108 that he/she is awake, then it transitions to awake state 1703. Once in awake state 1703, wakeup server 108 can start pushing into phone 101 the enhanced services described below (reminders/alerts). If the user does not confirm the wakeup call and the user activated the snooze feature in his/her profile, the state machine will transition to snooze state 1704. It will stay here for a given amount of time depending on the user's profile and then transition to making call state 1702 to try the wakeup call once again.

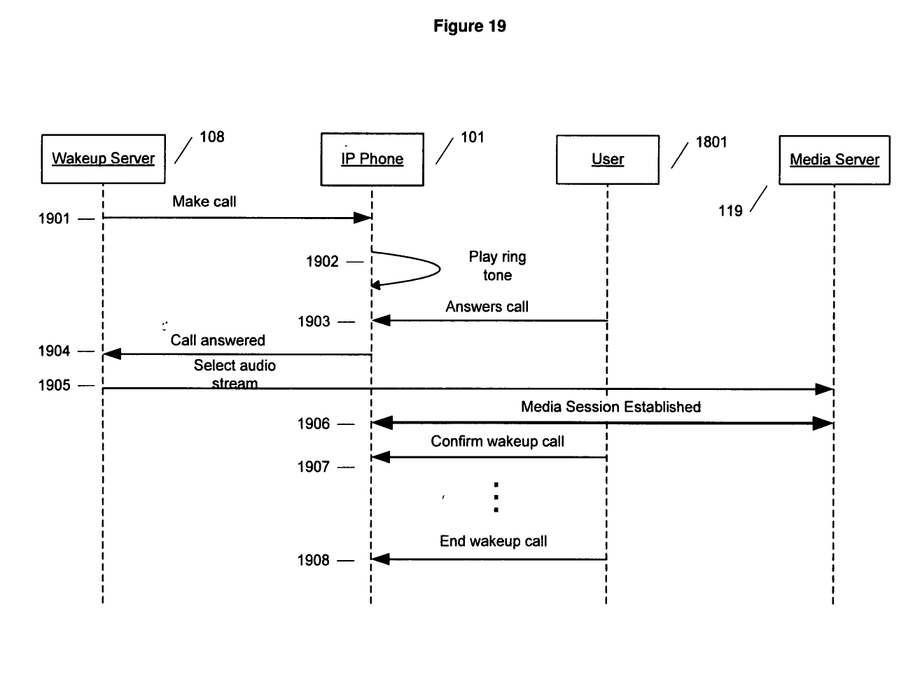

There are two main scenarios associated with an enhanced wakeup call. In the first scenario phone 101 automatically answers the call. This scenario is described in FIG. 18. In the second scenario, the user answers the call. This scenario is described in FIG. 19.

FIG. 18 shows (via arrows as indicated below) the sequence of events associated with phone 101 (FIG. 15) automatically answering a wakeup call in accordance with an embodiment of the present invention. Wakeup server 108 makes a call to IP phone 101 at the time of the wakeup call (arrow 1802). The call is flagged as a wakeup call. IP phone 101 examines the identity of the incoming call (arrow 1803) and automatically answers it if in fact it is a wakeup call (arrow 1804), thus signaling wakeup server 108 via the call answered signaling (arrow 1805). Wakeup server 108 contacts media server 119 to indicate user preferences, i.e., what sound will be transmitted (arrow 1806). Wakeup server 108 connects the local end of the media channel to media server 119 to transmit audio on real time (music, pre-recorded message, and live morning news) to phone 101. When user 1801 wakes up, user 1801 will provide confirmation to wakeup server 108, either hanging up the call or choosing to keep listening to media stream (arrow 1807). Any of these two actions will indicate to server 108 that the wake up call was successful (arrow 1808). If user 1801 does not carry out any of these two actions, server 108 disconnects the call after a given elapsed time and assumes that the wake up call was unsuccessful. After an elapsed time, user 1801 will finish the wakeup session (arrow 1809).

FIG. 19 shows (via arrows as indicated below) the sequence of events associated with user 1801 answering a wakeup call in accordance with an embodiment of the present invention. Wakeup server 108 makes a call to IP phone 101 at the time of the wakeup call with an identity that phone 101 can recognize as a wakeup call (arrow 1901). Terminal 101 starts ringing upon receiving the wakeup call. Since phone 101 can recognize the incoming call as a wakeup call, it can play the appropriate ringtone according to the current user configuration (arrow 1902). Ringtones can go beyond simple cadenced patterns and include more complex sound files such as short music clips and relaxing sounds (stored in the phone's non-volatile memory). When user 1801 wakes up, user 1801 will answer the call (arrow 1903) and the terminal will signal wakeup server 108 that the call was-answered (arrow 1904). Wakeup server 108 will connect the phone to media server 119 which will start transmitting the configured audio stream (arrow 1905) while the media session remains established (arrow 1906). User 1801 will provide confirmation to server 108 that he/she is awake, either hanging up the call or choosing to keep listening to the input audio stream (arrow 1907). If user 1801 does not pickup phone 101, server 108 will disconnect the call after a given elapsed time and assume that the call was unsuccessful. After an elapsed time, user 1801 will finish the wakeup session (arrow 1908).

The wakeup service described above can also provide a snooze feature similar to the one found in digital alarm clocks. In this case, wakeup server 108 initiates a wakeup call that can either be answered automatically by phone 101 or by user 1801. If the wakeup call fails (i.e., the user does not provide confirmation), server 108 will try again depending on the user configured callback settings. The wakeup call is unsuccessful if the user does not confirm the call in a given amount of time. Server 108 continues to initiate wakeup calls and check for success until it reaches a give-up condition specified in the configured user's profile. The number of times that server 108 calls back and the interval between calls can be customized for each user. For example, server 108 can call back every 10 minutes for half an hour with a relaxing sound and then after that period try a stronger sound at shorter intervals. If no answer is received, the system could trigger an alarm that would signal appropriate personnel to check on the well-being of the person for whom the wakeup call was setup (retirement home, hospital, hotel, etc).

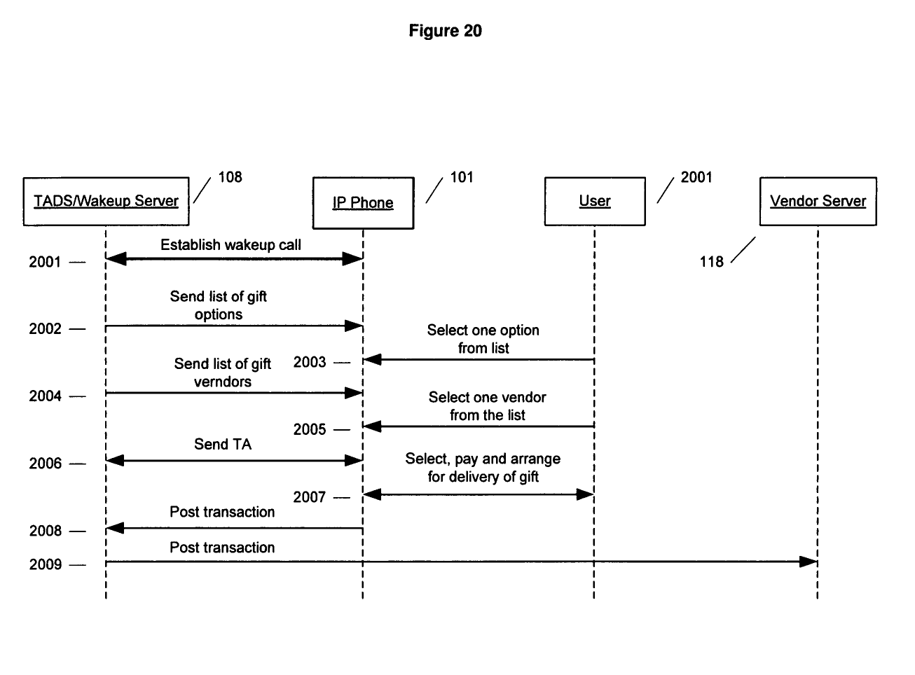

FIG. 20 shows (via arrows as indicated below) how the wakeup service can remind user 1801 of a special date in the calendar such as birthdays and anniversaries in accordance with an embodiment of the present invention. It allows user 1801 to arrange to buy and deliver a gift if appropriate. TADS/Wakeup server 108 and user 1801 establish a wakeup call that can either be answered automatically by phone 101 or by user 1801 (arrow 2005). Server 108 notices that today there's a birthday or anniversary entry in the user's calendar. Server 108 suggests a list of gift options (flowers, chocolates, book, etc.) (arrow 2006). User 1801 chooses a gift option (arrow 2007). Server 108 provides a list of local vendors for the gift category (arrow 2008). User 1801 selects a vendor from the list (arrow 1809). IP phone 101 downloads a transactional application (arrow 2010) to allow user 1601 to select, pay and arrange delivery of the gift (arrow 2011). User 1801 interacts with IP phone 101 to place the order. Phone 101 posts the transaction with server 108. TADS server 108 posts the transaction with the particular vendor server 118. Alternatively, user 1801 could call the vendor with just the press of a button to place the order since TADS server 108 could already provide the contact number.

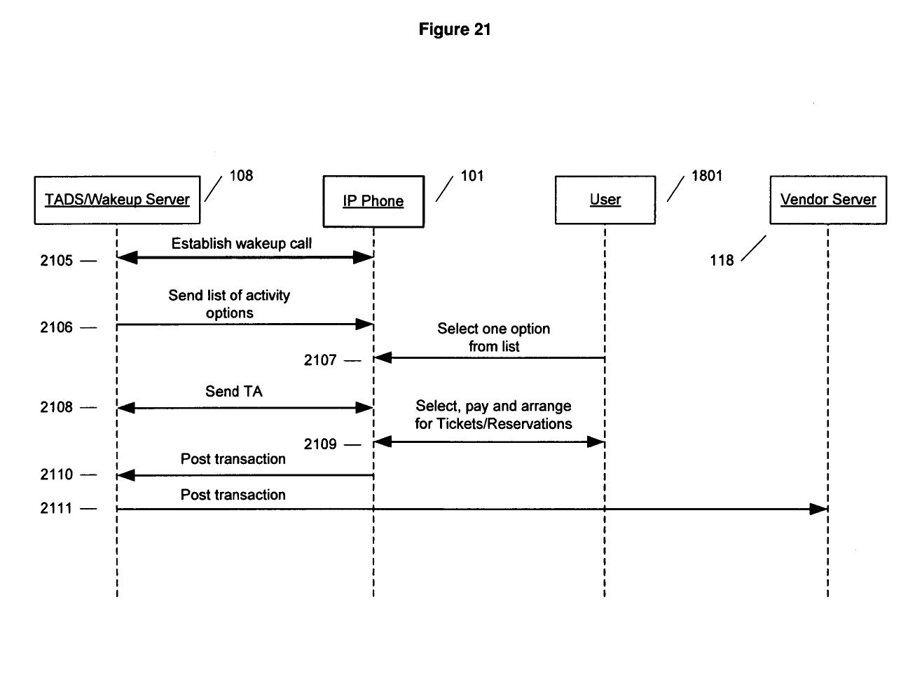

FIG. 21 shows (via arrows as indicated below) how the wakeup service can alert user 1801 of special entertainment events that might be of his/her interest and allow user 1801 to reserve or buy tickets to these events in accordance with an embodiment of the present invention. TADS/Wakeup server 108 and user 1801 establish a wakeup call that can either be answered automatically by phone 101 or by user 1801 (arrow 2101). Server 108 notices the date and provides user 1801 with a list of weekend activities (concerts, movies, theater, conferences, trip special packages) that matches a list of interests in the user's profile stored in server 108 (arrow 2102). User 1801 chooses an activity from the list (arrow 2103). Phone 101 downloads an application (arrow 2104) to allow user 1801 to buy tickets and make/confirm reservations (arrow 2105). User 1801 interacts with IP phone 101 to place the order. Phone 101 posts the transaction with server 108 (arrow 2106). TADS server 108 posts the transaction 1811 with particular vendor server 118 (arrow 2107).

A combination of the services described in association with FIGS. 20 and 21 can be envisioned for the hospitality industry. The wakeup service shows user 1801 what is available in the hotel restaurant menu or the list of activities/tours for the day. Server 108 and user 1801 establish a wakeup call. Server 108 shows user 1801 the hotel restaurant breakfast menu and a list of activities for the day. Phone 101 downloads an application to let user 1801 order room service for breakfast or reserve tickets for a given activity.

FIG. 22 shows (via arrows as indicated below) how the wakeup service can send the user 1801 urgent unread emails or voicemails that arrived during the night and that may require immediate attention during the morning in accordance with an embodiment of the present invention. TADS/Wakeup server 108 and user 1801 establish a wakeup call that can either be answered automatically by phone 101 or by user 1801 (arrow 2201). Server 108 requests messaging server 110 for information of new urgent emails or voicemails during late hours for the current user (arrow 2202). Alternatively, messaging server 110 can notify wakeup server 108 when a new message arrives. Then, server 110 can check if there are any messages logged at the time of the wakeup call. Phone 101 downloads an application to let user 1801 see and hear the list of urgent messages and answer any if appropriate (arrow 2203). User 1801 browses the message list (arrow 2204) and requests (arrow 2205) more information for a particular message. Phone 101 shows the text or plays the selected message (arrow 2206). After reviewing a message, user 1801 can use phone 101 to answer if appropriate (arrow 2207).

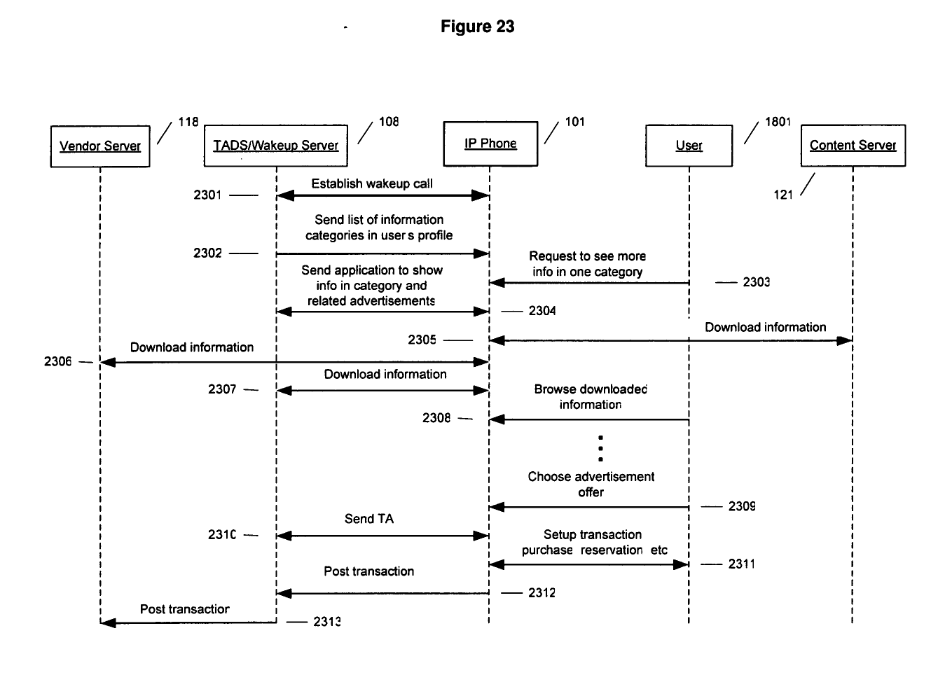

FIG. 23 shows (via arrows as indicated below) how the wakeup service can send user 1801 the information that might be of interest while waking up (usually during the morning) such as news headlines, local weather conditions, sport results, and stock quotes (collectively referred to as “newspaper material”) in accordance with an embodiment of the present invention. TADS/Wakeup server 108 and user 1801 establish a wakeup call that can either be answered automatically by phone 101 or by user 1801 (arrow 2301). Server 108 sends a list of information categories to choose from based on the user's preferences (arrow 2302). User 1801 selects the information category he/she wants to browse (arrow 2303). Server 108 sends phone 101 the application to present the information to user 1801 (arrow 2304). Each category of interest may initiate a download from content server 119, vendor server 118, or TADS/wakeup server 108 (arrows 2305, 2306, 2307). Server 108 shows the user (arrow 2308) information of personal interest during the morning such as: task list and appointments for the day, news headlines, local weather, traffic conditions, sport results, inspirational/funny quotes and cartoon strips. User 1801 may initiate a transaction based on an advertisement posted by TADS server 108 along with the information of interest (arrow 2309). Server 108 sends the transactional application (arrow 2310). The transaction is setup by user 1801 via IP phone 101 (arrow 2311). The transaction is posted to TADS server 108 (arrow 2312) and ultimately to vendor server 118 (arrow 2313).

A service enabled by an embodiment of the present invention related to the development of enhanced data integrity methods that can leverage the TADS building blocks discussed in FIGS. 14-15 and software platform 500 (FIG. 5) to facilitate the maintenance of digital directories, such as yellow pages, is discussed below in association with FIGS. 24-26. That is, FIGS. 24-26 disclose a method for identifying phone numbers made by a user of IP phone 101 that did not contact intended recipients. Further, FIGS. 24-26 disclose a method for identifying a failed directory search of a contact performed by a user of IP phone 101.

The enhanced methods are based on the availability of a so-called TADS/YellowPages (YP) alarm server 108 (discussed further below in connection with FIG. 24) that has a mechanism by which it can receive an alarm from an IP Phone 101 indicating a failure to complete a call to a particular phone number or URI. This alarm mechanism can be either manual via UI event handler 1506 or automatically triggered by the error response code to the call. The alarm can be classified as critical (generated manually) or info (generated automatically). In both cases, an administrator 2408 (FIG. 24 as discussed below) has the ability to select the failure threshold that will lead to the alarm generation.

FIG. 24 shows (via arrows as indicated below) the sequence of events associated with the selectable failure threshold—manual solution in accordance with an embodiment of the present invention. Referring to FIG. 24, a telephony services server 109 sends a wrong number (a number which the user tries to reach but turns out to be the wrong number) and/or SIP/H323 error message 2401 to IP phone 101 together with an error sound or announcement. IP phone 108 displays a “broken link” type of button via the interface provided by UI event handler 1506. The user will trigger the alarm report by pressing on the button. This action will send a “critical alarm” message (arrow 2402) to TADS server 108 (via the transaction broker module 1508 and TADS client protocol engine 1301), indicating a “bad phone number.” The critical alarm message will cause TADS server 108 to increment the corresponding alarm count for the called number (arrow 2403). Once the alarm count of a phone number reaches the selected failure threshold, the number will be flagged (arrow 2404) and displayed on TADS front end console 1201. Directory administrator 2208 would then see the flagged number (arrow 2405) and would launch an investigation to determine why the failure is occurring (disconnected number, changed number, etc.) (arrow 2406). Once the cause of the failures is determined, administrator 2408 proceeds to update the database to avoid future call failures (arrow 2407).

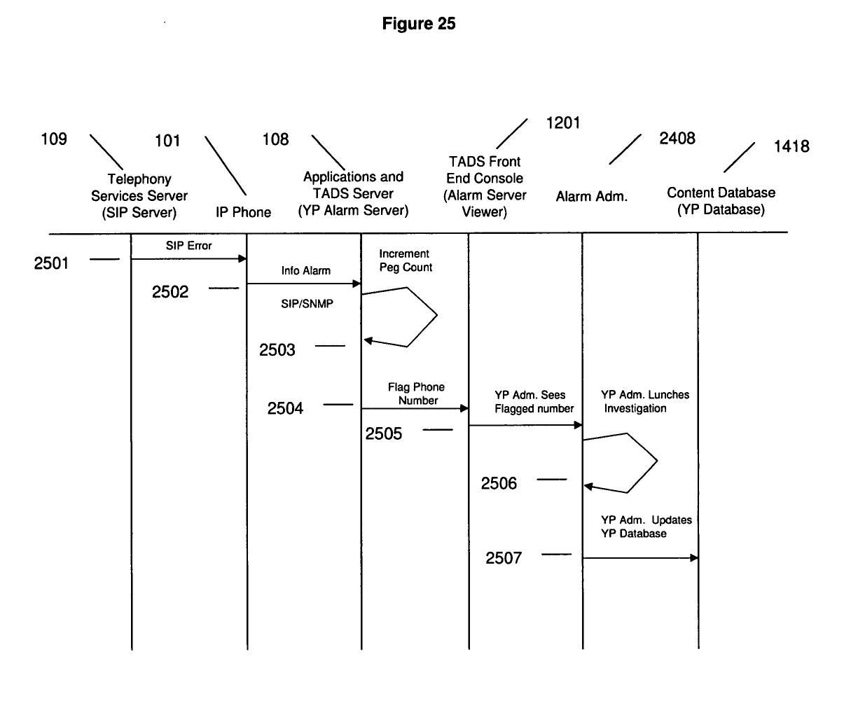

FIG. 25 shows (via arrows as indicated below) the sequence of events associated with the selectable failure threshold—automatic solution in accordance with an embodiment of the present invention. Referring to FIG. 25, telephony services server 109 sends a SIP error message (with any of the following SIP error codes: 301, 404, 410 and 604) to IP phone 101 (arrow 2501). Upon receiving the error message, IP phone 101 will generate an info alarm (arrow 2502) that will be sent to TADS server 108 (via the TA execution module 1303 and TADS client protocol engine 1301), indicating a “bad phone number.” The info alarm message will cause TADS server 108 to increment the corresponding alarm count for the called number (arrow 2503). Once the alarm count of a phone number reaches the selected failure threshold, the number will be flagged (arrow 2504) and displayed on TADS front end console 1201 Directory administrator 2408 would then see the flagged number (arrow 2505) and would launch an investigation to determine why the failure is occurring (disconnected number, changed number, etc.) (arrow 2506). Once the cause of the failures is determined, administrator 2408 proceeds to update the database to avoid future call failures (arrow 2507).

FIG. 26 shows (via arrows as indicated below) the detailed sequence of events associated with the selectable failure threshold applicable to both the manual and automatic methods previously described in accordance with an embodiment of the present invention. Referring to FIG. 26, telephony services server 109 sends a SIP or wrong number (a number which the user tries to reach but turns out to be the wrong number) error message (with any of the following SIP error codes: 301, 404, 410 and 604) to IP phone 101 (arrow 2601). Upon receiving the error message, IP phone 101 will send a message to TA execution engine 1303 (arrow 2602), UI event handler 1506 waking the system with an alarm. TA execution engine 1503, UI event handler 1506 deliver the alarm to transaction broker module 1508 (arrow 2603), which in turn delivers the alarm to TADS client protocol engine 1101 (arrow 2604) so that it can be forwarded using the TADS protocol to TADS server protocol engine 1206 (arrow 2605). TADS server protocol engine 1206 reports the alarm to transaction engine (alarm manager) 1411 (arrow 2606) which increments the corresponding alarm count (arrow 2607) and records it on transaction database 1417. If the thresholds are met, transaction engine (alarm manager) 1411 will flag the phone number (arrow 2608) and display on TADS front end console (alarm viewer) 1201. Once alarm administrator 2408 sees the flagged number (arrow 2609), he/she will launch an investigation (arrow 2610) and if appropriate will update (arrow 2611) the yellow pages database 1418.

In both the manual and automatic methods described above, TADS server protocol engine 1206 will receive the alarms and will store them on transaction database 1417 until they are cleared or saved into an alternative location. An alarm manager application will be monitoring the alarms or alarm counts depending on the administrator configured data. This application will make the alarms available to the system administrator by displaying them using TADS front-end console 1201. The yellow pages administrator can view a report of the flagged numbers in order to start an inquiry about the validity of a particular alarmed or flagged number. The alarm mechanism can be implemented either by using SIP (SUBSCRIBE/NOTIFY) messages, SNMP based traps or similar protocols and services. If SNMP is used, the object identifiers for the management information base and the way they should be interpreted defines this part of the TADS communications protocol. If the SIP SUBSCRIBE/NOTIFY mechanism is used, then the schema of the XML files exchanged with the two kinds of messages defines the TADS communication protocol for this service. TADS client protocol engine 1301 can provide programmatic interfaces to creating and parsing said objects or files. Note that the methods described above use alarms as the primary type of event, but it could be extended to use other events in order to create more elaborate schemes to update the directory databases. For example, traffic measurements could be used where the number of yellow pages local searches made against number of local searches that ended generating a call is used as a performance indicator.

In both the manual and automatic methods described above, the content of alarm messages may include the ID, severity (Info, Critical, Other), type (contact, graphics, etc.), query, query return, error source, and cause source. The error triggers may be generated by IP phone 101. Error sources may include IP phone 101, dial plan, or null searches (search returning a contact with no phone number). The cause code may include blank number, garbled number, (letters instead of numbers), SIP error code, manual (user notifies the error), etc. The alarm type may include wrong graphics or phone numbers.

) A service enabled by an embodiment of the present invention related to the development of a self-fulfillment method that can leverage the TADS building blocks discussed in FIGS. 14-15 and software platform 500 (FIG. 5) to facilitate the management of phone directory updates is discussed in association with FIG. 27.

Often times a vendor may have to transfer phone lines from one location to another. While the phone numbers remain the same, the geographical location associated with them changes. It takes many months for service providers to update their systems to reflect the change. This could lead to a potential loss of customer leads when customers search for local merchants.

FIG. 27 is a flowchart of a method 2700 for facilitating the management of directory updates via vendor self-fulfillment in accordance with an embodiment of the present invention. Referring to FIG. 27, in step 2701, the vendor connects to TADS server 108 via front end Console 1201 and gains access to his records via vendor management module 1404. In step 2702, the vendor updates, corrects, or sets up the contact info associated with the phone lines of interest. In step 2703, TADS server 108 generates a validation code that is sent, along with a phone number to call, to the vendor's email address. In step 2704, the vendor calls the phone number provided by the TADS server from the line for which contact information was updated (with caller ID enabled) and when prompted enters the validation code. In step 2705, TADS server 108 generates a new email or fax that is sent to the vendor indicating that the phone line contact info has been successfully updated.

It is noted that method 2700 may include other and/or additional steps that, for clarity, are not depicted. It is further noted that method 2700 may be executed in a different order presented and that the order presented in the discussion of FIG. 27 is illustrative. It is further noted that certain steps in method 2700 may be executed in a substantially simultaneous manner.

A service enabled by an embodiment of the present invention related to the development of enhanced merchant-customer interaction methods that can leverage the TADS building blocks discussed in FIGS. 14-15 and software platform 500 (FIG. 5) to facilitate communication among said parties is discussed below in association with FIGS. 28-29. Specifically, a “click to dial” and a “more info” solution are presented. The “click to dial” solution allows an end-user to click on a button placed on a participating merchant's webpage leading the end-user's IP phone in turn to place a call to the corresponding number. The “more info” solution allows an end-user to click on a button placed on a participating merchant's webpage or phone-based advertisement leading the merchant to place a call to the end-user's IP phone.

FIG. 28 shows (via arrows as indicated below) the sequence of events associated with the “click to dial” enhanced merchant-customer interaction method in accordance with an embodiment of the present invention. A browser plug-in or small application called a Remote VoIP Call Dispatcher (RVCD) 2802 would be installed on the user's personal computer. This software would be configured with IP phone 101 information for the user in the form of a URI. Alternatively, an IP phone 101 auto-discovery mechanism can be implemented where RVCD 2802 broadcasts to its subnet a request for identification to all listening IP phones 101. IP phones 101 will respond to the request with an TADS echo message indicating Internet Protocol contact information, and credentials to be authenticated by the requester. This can also be accomplished if IP phone 101 broadcasts periodically a SIP message invocating a SUBSCRIBE method with all the information needed by the RVCD 2802. Web server 108 will contain advertisement pages 2801 which will be formatted with SIP based URIs. Upon the end-user 2801 clicking on an advertisement (arrow 2803), phone number or SIP URI, the web browser will pass the URI (arrow 2804) to RVCD 2802. Once RVCD 2802 receives the target URI, it will send a SIP message invocating the REFER SIP method (arrow 2805) to the user's IP phone 101 in order to generate a new call towards the merchant 1801 contact (arrow 2806). Alternatively, RVCD 2602 could send a NOTIFY message (arrow 2805) to IP Phone 101 using information previously received by RVCD 2802 in a SIP SUBSCRIBE message, to generate the new call (arrow 2806), but the preferred method is to use the REFER method. Once the call is accepted, conversation is established (arrow 2807).

FIG. 29 shows (via arrows as indicated below) the sequence of events associated with the “more info” enhanced merchant-customer interaction method in accordance with an embodiment of the present invention. A local HTML page 2801 will be available to the local end-user's 1801 personal computer. This page 2801 will contain a form that once filled, it will generate a cookie which will be stored on personal computer 1801. The cookie will contain the contact information for the user (URI, telephone number, etc.). Alternatively, page 2801 served by web server 108 should also contain a way to request the contact info in case the cookie is not available. Web server 108 will contain an application which would be used to track and manage the “request more info” transactions. The request for info transactions will be presented in a sequential manner on a GUI available through this application. These request for info transactions could be a one time only transaction as well as a subscription transaction. In case of a subscription transaction, the requester can select how to get the subscription content by e-mail or by targeted advertisement on IP phone 101. Web server 108 will serve specially formatted advertisement pages (arrow 2901) that will contain a Java Script which will be used to fill up a hidden form by reading the cookie previously generated by the local page when the page is loaded by the web browser. Alternatively, the page served by web server 108 should also contain a way to request the contact info in case the cookie is not available. These pages can be considered to be TADS transaction applications. The cookie can be considered a user's profile. When end-user 1801, who is browsing the page, clicks on the “request for more info” link (arrow 2902), the browser will send the form towards the server (arrow 2903). This form will have a set of values (item ID, topic ID, inventory ID) hard-coded at server 108 which will be used to determine the request for info type. Upon receiving the form by TADS server 108, the information would be saved in a database 808 (arrow 2904) and presented to a user (arrows 2905, 2906, 2907) through TADS front end console 1201 previously described for a customer representative 2808 to use. The front-end console will be provisioned so that it retrieves content periodically from the database (arrow 2905). Once the new requests are obtained from the database (arrow 2906), they will be displayed on the front-end console. At this point, customer representative 2808 will call the client in order to provide the requested information (arrow 2908). Alternatively, customer representative 2808 will send the targeted content to IP phone 101 (arrow 2909). The information retrieved through the form can be used in order to collect and store demographic statistics.

A service enabled by an of the present invention related to the development of enhanced auto-conference call methods that can leverage the TADS building blocks discussed in FIGS. 14-15 and software platform 500 (FIG. 5) to facilitate the automatic generation and management of conference calls is discussed below in association with FIGS. 30-32. Three methods are presented based on phone synchronization, phone subscription, and server hosted conferences.

The enhanced methods are different from current ones in that TADS enabled user-profiles can be set up to be combined with the user's calendar, directory and profile settings to automatically manage conference-calls based on the desired rules. For example, a user would not have to remember to set call forwarding at a particular time or to reschedule a scheduled conference call to another time due to a scheduling conflict. The users could create rules taking into consideration the user's calendar, directory and profile settings. For example, the user could create a rule that indicates that “from 6 am to 6 pm, if calendar indicates meeting, then forward calls to <phone 2>.” TADS-based user-profiles allow for mobility of information so that all TADS-enabled communication devices could load your user profiles without the need for programming the rules in each location. The integration of the user's calendar, the user's profile and rules allows more freedom for users and allows for enhanced responses by combining the rules with finer grained functionality (e.g., the users do not have to remember to set the vacation message in the phone). The users can set a rule that whenever the calendar says out of the office, the phone will send the vacation message indicating when the user will come back, except for calls from phone-X which will be automatically forwarded to phone-Y.

The methods described herein are based on user-profiles. Users will have access to TADS based user-profiles to specify how they want to handle the auto conference feature. These profiles can contain preferences for the user on how to handle incoming calls, or make outgoing calls based on specific rules. User-profiles are mobile. When users move from location to location, they can decide to bring all or part of their profile to the new location. For example, users might want to have in their user-profile settings for home, business, travel, etc. The user-profile, combined with the auto conference feature, can set rules for call handling depending on phone/calendar situation. Some possible rules may be: do not disturb; call forwarding; automatic message response; priority based interrupt.

Sample uses of the rules are now discussed. For example, the “Do Not Disturb” rule is used when a user is already in a conference call, or at any time in the day when they need privacy. By using the “Do Not Disturb” rule, the user can set this rule so that incoming calls and messages go directly to voice mail. “Call Forwarding” could be set so that at specific times in the day calls are automatically forwarded to different numbers. For example, in a work sharing situation, two employees may set call forwarding to automatically forward calls to each other during each other's lunch hour. “Automatic Message Response” allows for a particular message to be sent back to callers at particular times. For example, if a user's schedule indicates that the user will be out of the office for 2 hours at the time of receipt of a call, there could be an automatic message response asking the caller to leave a message and informing the caller that the message will be received in 2 hours. “Priority Based Interrupt” is a rule that can be set to allow phone calls to interrupt any other calls. For example, one could set a priority based interrupt to receive notification of all calls from a child's school, even in the middle of a meeting, overriding the “do not disturb” rules.

FIG. 30 shows (via arrows as indicated below) the sequence of events associated with the auto-conference call phone synchronization solution in accordance with an embodiment of the present invention. This method requires synchronization of IP phone 101 with a TADS enabled personal computer or workgroup server 108 based calendar application. It also requires having a thin calendar based application 3002 running on IP phone 101. User A 1801 schedules a meeting (arrow 3005) via TADS server 108 calendar application. The calendar application in turn creates a conference call meeting profile and sends the profile to TA distribution engine 1413 (arrow 3006). This profile will contain the contact information (e.g., phone numbers) for all the conference participants as well as other conference-related properties such as a set of instructions which are to be followed upon profile activation. TA distribution engine 1413 sends the profile to TA distribution engine 1413 (arrow 3006) which in turn sends the profile to the phone A calendar application 3002 (arrow 3007), which in turn saves the profile to installed application database 1302 (arrow 3008) and will assign an ID to it. The meeting profiles are considered TA as they will be executed at a particular time by TA execution engine 1411. At the time of the conference call meeting, IP phone 101 will load this profile and call TA execution engine 1411 in order execute the profile (arrow 2809). Once IP phone 101 starts executing the profile, TA execution engine 1411 will instruct IP phone 101 to generate a conference call to the pertinent participants (arrow 3010). At this point, phone A 101 proceeds to invite phone B 116 and phone C 117 to enter the conference.

The auto-conference call phone subscription method requires the installation of a plug-in application on a TADS enabled personal computer or workgroup server 108 based calendar application. This plug-in will have access through user management module 1409 to the user profiles which would be stored on the consumers database 108. The user profiles will be used to determine the call processing preferences for that user as defined previously. The profiles will be sent by making use of the TA distribution engine 1413 as soon as the client IP phone 101 subscribes. This plug-in will also be responsible of sending Notify messages to VoIP phone 101 upon time to start a meeting. This Notify message contains a new “Auto-Conference” XML dialog which includes all the URI or contact information for the meeting participants. A new call control feature will be added to IP phone 101 which will use these Notify messages and upon parsing the content of the XML dialog, it will generate (Host) a conference to the meeting participants.

FIG. 31 shows (via arrows as indicated below) the sequence of events associated with the auto-conference call phone subscription solution in accordance with an embodiment of the present invention. Phone 101 schedules a meeting via the client PC 112 (arrow 3102) using the calendar application residing on TADS server 108. Phone A 101 registers with SIP server 109 (arrow 3103) and subscribes to the auto-conference service via the calendar application on TADS server 108 (arrow 3104). TADS server 108 sends phone A 101 the corresponding subscriber profiles (arrow 3105). At the time of the conference call meeting, TADS server 108 notifies phone A 101 that a new conference call should be established (arrow 3106). Phone A 101 sends an invite message to establish communication with phone B 116 via SIP server 109 (arrow 3107), which in turn forwards the invitation to phone B 116 (arrow 3108). Phone A 101 sends an invite message to establish communication with phone C 117 via SIP server 109 (arrow 3109), which in turn forwards the invitation to phone B 116 (arrow 3110).

FIG. 32 shows (via arrows as indicated below) the sequence of events associated with the auto-conference call phone subscription solution in accordance with an embodiment of the present invention. Phone A 101 schedules a meeting using the calendar application residing on TADS server 108 (arrow 3201). TADS server 108 stores the configuration profile on consumer's database 1408 and assigns an ID to it (arrow 3202). This profile will contain the contact information (e.g., phone numbers) for all the conference participants as well as information for the SIP multi-conference unit. The profile contains a set of instructions which are to be followed upon profile activation. At the time of the conference call, the calendar application residing on TADS server 108 requests the profile from consumer's database 1408 (arrow 3203), receives the profile (arrow 3204) and sends it to TA Distribution Engine 1413 (arrow 3205) which signals the TADS based SIP MCU 109 (SIP Multi-Conference Unit) that it should start a conference call (arrow 3206). TADS based SIP MCU 109 invites phone A 101 (arrow 3207), invites phone B 116 (arrow 3208), and invites phone C 117 (arrow 3209) to join the conference call.—The advantage of this method is that it is centralized from TADS server 108, thus the number of conference participants is not limited by the phone. This solution requires a calendar based application running on the server and that the server be configured with the information for a SIP multi-conference unit.

A service enabled by an embodiment of the present invention related to the development of enhanced usage control methods that can leverage the TADS building blocks discussed in FIGS. 14-15 and software platform 500 (FIG. 5) to facilitate the control of the usage of IP phones via user profiles that specify allowed and disallowed data and call transactions is described in association with FIGS. 33-34.

The enhanced methods are based on using profiles in the phone combined with information in TADS server 108 (consumer database 1408). An administrator of TADS enabled devices can create rules for what content and calls can be sent and received in the phone. “Content” refers to content and applications served from TADS. The profiles associated with calls may include allowed lists of numbers to call, numbers to receive, forbidden numbers to call, and forbidden numbers to receive. The profiles associated with data may include allowed content to receive, allowed information sites to access, forbidden content to receive, and forbidden information sites to access. These values are stored in consumer database 1408 associated with TADS server 108, and may be associated with distribution schedules 1410 (in cases where content/calls to be allowed/disallowed vary during the day). Profiles will be administered via a TADS Front End Console 1201 or other tools provided developed using the TADS Programmatic API 1403 to make entering or editing this information simple so that end users do not have to understand the actual format of these profile values. For example, a national, state or world map could be displayed and let users decide which area codes/city codes/country codes to allow or disallow. The front-end could also provide the ability to go thru the call/application logs to directly ADD and REMOVE numbers or applications to the appropriate lists. The lists could be added to “group” profiles (distribution groups) so that they could be easily assigned to multiple phones. For example, you can define a “building 1 phones” group which can not call anywhere in Europe, but “building 2 phones” group can. Other options may be to create distribution groups that associate all phones from one person. For example, user A might want to avoid calls from user B no matter where he is. User A may create a profile that includes user B's home phone, cellular and business phones, and user B's TADS enabled computer system and Personal Digital Assistant (PDA). In this profile, user A adds user B's phone numbers to a list that includes phone numbers that are forbidden to contact and user B's instant message ID name to a list that includes contacts that user A is forbidden to receive. The allowed and forbidden information could alternatively be stored in an external media that could be moved with the person as needed. For example, a USB drive could be used to store this information and when connected to the TADS enabled device it would add these rules. The allowed and forbidden information could alternatively be sent directly from TADS enabled device to another TADS enabled device (for example, by emailing between two TADS enabled computers). Phones or phone groups (distribution groups) can be associated with specific instructions on what to control and when. These lists are also associated with “schedules” so that the numbers allowed to call/receive (or data/application accesses) could be different at different times of the day. Some examples of how administrators may control usage include: parents who decide that specific phones should not make calls after 10 p.m.; employers may create “do not call” lists to block specific phone numbers from being called (e.g., 976 numbers, long distance calls, etc.); parents could block TADS server games and content from 6 p.m. to 6 a.m. from their children's phones; and employers can block employee's access to some TADS content that might not be appropriate for their companies.

FIG. 33 shows (via arrows as indicated below) the sequence of events associated with the usage control method in connection with content distribution scenarios in accordance with an embodiment of the present invention. The usage administrator logs in to TADS Server 108 via client personal computer 112 and edits preferences (profiles) for all phones under a specific group of interest (e.g., “home”) (arrow 3301). TADS server 108 (using the user management module 1409, the group subscriber/unsubscriber module 1014, and content programming module 1406) stores the profile preferences in consumer database 1408 (arrow 3302). Phone A 101 and phone B 116 are assigned to a distribution group using group subscription management module 1414. The profiles are stored in consumer database 1408 with possible associations made in a distribution group schedule 1410 for rules that apply only at certain times. When phone A 101 initiates a request for content (arrow 3303), TADS server 108 accesses the profile information from consumer database 1408 to determine if this is an allowed transaction (arrow 3304). Consumer database 1408 returns the profile information (arrow 3305). If the request for content is allowed, TADS server 108 sends the content to phone A 101 (arrow 3306). When phone B 116 initiates a request for Content (arrow 3307), TADS server 108 accesses the profile information from consumer database 1408 to determine if this is an allowed transaction (arrow 3308). Consumer Database 1408 returns the profile information (arrow 3309). If the request for content is forbidden, TADS server 108 sends an error message to phone B 116 (arrow 3311).

FIG. 34 shows (via arrows as indicated below) the sequence of events associated with the usage control method in connection with call control scenarios in accordance with an embodiment of the present invention. The usage administrator logs in to TADS Server 108 via client personal computer 112 and edits preferences (profiles) for all phones under a specific group of interest (e.g., “home”) (arrow 3401). TADS server 108 (using a user management module 1409, a group subscriber/unsubscriber module 1414, and a content programming module 1406) stores the profile preferences in consumer database 1408 (arrow 3402). Phone A 101 and phone B 116 are assigned to a distribution group using group subscription management module 1414. The profiles are stored in consumer database 1408 with possible associations made in a distribution group schedule 1410 for rules that apply only at certain times. When phone A 101 initiates a request for a call to phone B (arrow 3403), TADS server 108 accesses the profile information from consumer database 1408 to determine if this is an allowed transaction (arrow 3404). Consumer database 1408 returns the profile information (arrow 3405). If the request for the call is allowed, TADS server 108 sends an allow call message to phone A 101 (arrow 3406). Phone A 101 then invites phone B 116 for a call (peer to peer scenario) (arrow 3407). If the profile indicates that phone B 116 cannot be called from phone A 101, then TADS server 108 will return a forbidden call message to phone A 101 (arrow 3408).

A service enabled by an of the present invention related to the development of enhanced user experience methods that can leverage the TADS building blocks discussed in FIGS. 14-15 and software platform 500 (FIG. 5) to facilitate the control and distribution of content to hospitality phones is discussed in association with FIG. 35.

TADS front end tool 1201, content programming module 1406, or 3rd party implementations using TADS programmatic API 12014033 can be used to generate content “packages” to be displayed in TADS enabled devices (e.g., IP phone 101). These packages may have all the information to display customized content, and provide the user with controls that they can use to access content that may not be stored locally in the TADS enabled device. Hotels and content providers can create TADS enabled applications 411 (FIG. 4) to help customers with various needs, such as check-in/check-out assistance and information, billing information, room service orders, concierge services and more. Through TADS enabled applications, hotel rooms can gain access to web-based feeds of news, sports, entertainment, financial and weather content for display directly to customers' rooms. This combined with the potential of user specific TADS enabled profiles means a user can have a wealth of information and services automatically sent to their rooms. The hotel's Property Management System (PMS) Which stores information such as reservations information, check-ins and check-outs, rates, charges/billing information, guest profiles, alerts, and more, could be accessed to customize the content that is sent to phones by content programming module 1406. TADS transaction engine 1411 would have software for content handlers/converters (applications that convert from external formats of information, e.g., PMS data, web-feeds, other web sites, to data that can be sent and understood by the TADS enabled devices.

TA Execution Engine 1403 in the TADS-enabled client will use these packages to display content and respond to user events. Content programming module 1406 can be used, in combination with a hotel's Property Management System (PMS), to schedule and show targeted content to rooms in the hotel. Packages could be assigned to room distribution groups by using the group subscription management module 1414. Multiple rooms could be associated with different distribution groups. This would allow a hotel to have separate “packages” that could be assigned to different room “groups.” Packages could be reused. For example, the same package could be sent to different hotels in the same chain, shared amongst hotels in multiple chains, or even sold in shrink-wrapped version so that smaller hotels could use as pre-packaged solutions.

If a guest has a TADS enabled profile (an entry in a TADS consumer database 1208) they could choose to add their TADS-enabled content directly to their hotel room using TA distribution engine 1413 and product delivery engine 1415. This allows them to access their preferred content in addition to the hotel's recommended content, thus enhancing their experience. This would require that the hotel have allowed external access to the consumer's TADS server or that the consumer provided the information via USB drive 214 (FIG. 2).

FIG. 35 is a flowchart of a method 3500 to define the user experience as defined by content and application distribution to TADS enables devices in accordance with an embodiment of the present invention. Referring to FIG. 35, in step 3501, the content administrator 3607 identifies local and remote content and applications for distribution packages. In step 3502, the content administrator 3607 defines distribution groups and associates the packages. In step 3503, the system administrator 3607 distributes the packages.

It is noted that method 3500 may include other and/or additional steps that, for clarity, are not depicted. It is further noted that method 3500 may be executed in a different order presented and that the order presented in the discussion of FIG. 35 is illustrative. It is further noted that certain steps in method 3500 may be executed in a substantially simultaneous manner.

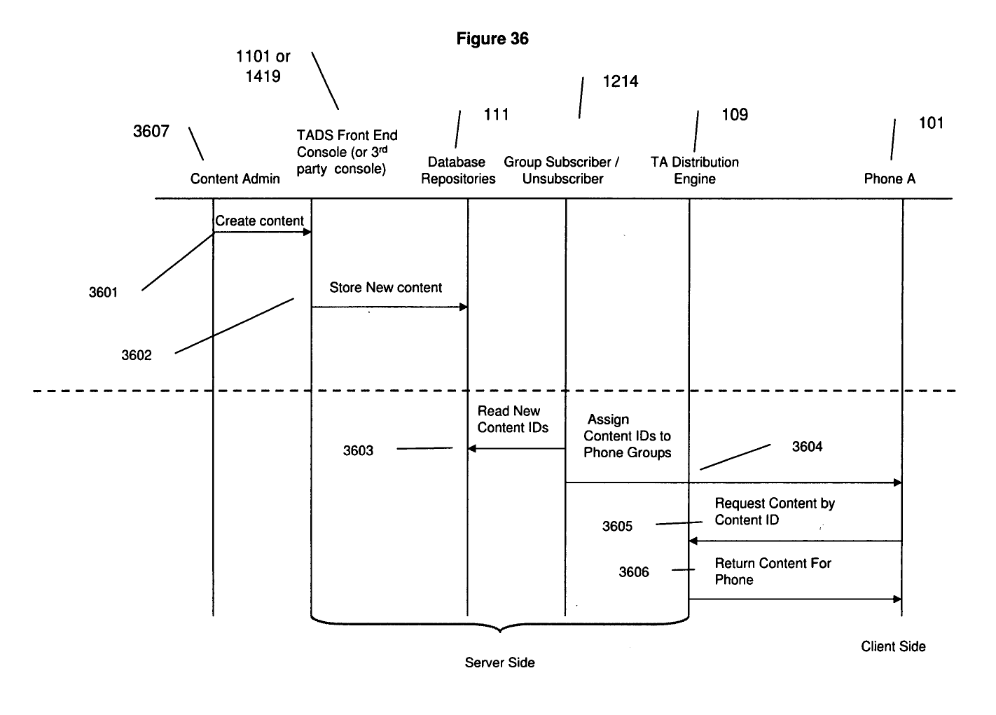

FIG. 36 shows (via arrows as indicated below) the sequence of events associated with assigning content to phones. The content administrator 3607 creates content via TADS front-end console 1201 or third party console 1419 (arrow 3601) and stores it on database repository 111 (arrow 3602) and assigns profiles to the phone groups via group subscriber/unsubscriber module 1414 (arrow 3603). Group subscriber/unsubscriber module 1414 reads (arrow 3603) new content IDs from database repositories 111 and assigns content IDs to phone groups (arrow 3604). When Phone A 101 requests content associated with its ID (arrow 3605), TA distribution engine 109 will return the corresponding content (arrow 3606).

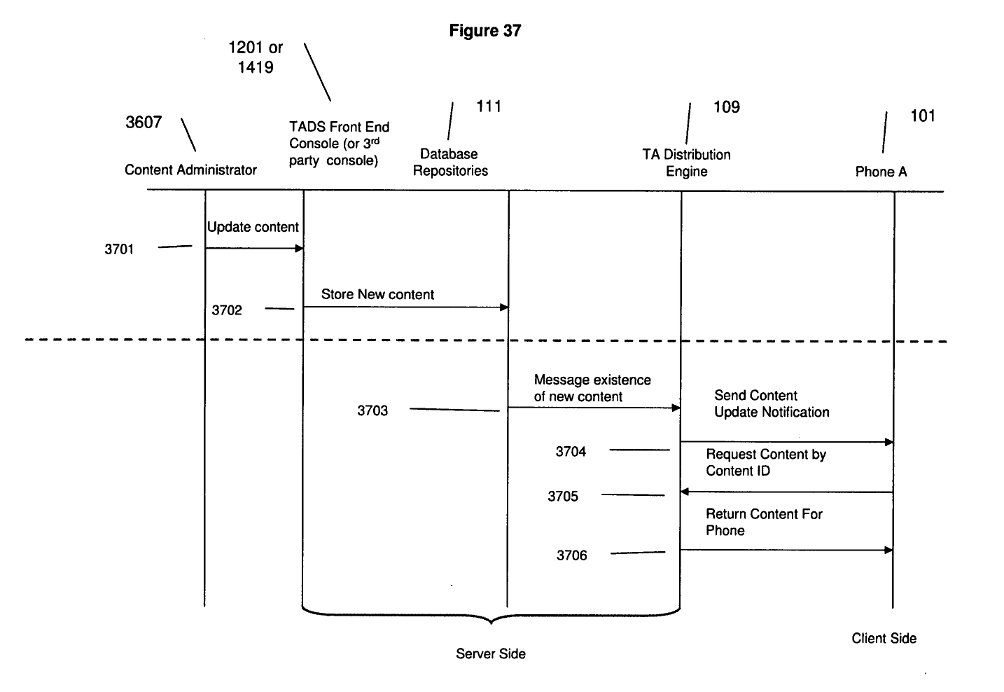

FIG. 37 shows (via arrows as indicated below) the sequence of events associated with updating existing content in accordance with an embodiment of the present invention. User A 3607 updates content via TADS front-end console 1201 or third party console 1419 (arrow 3701) and stores it on database repository 111 (arrow 3702), from which a message is generated to TA distribution engine 109 notifying of new content (arrow 3703). TA distribution engine 109, in turn, sends an update notification to Phone A 101 (arrow 3705). The updated content is then exchanged between TA distribution engine 109 and phone A 101 via content request (arrow 3705) and content return (arrow 3706).

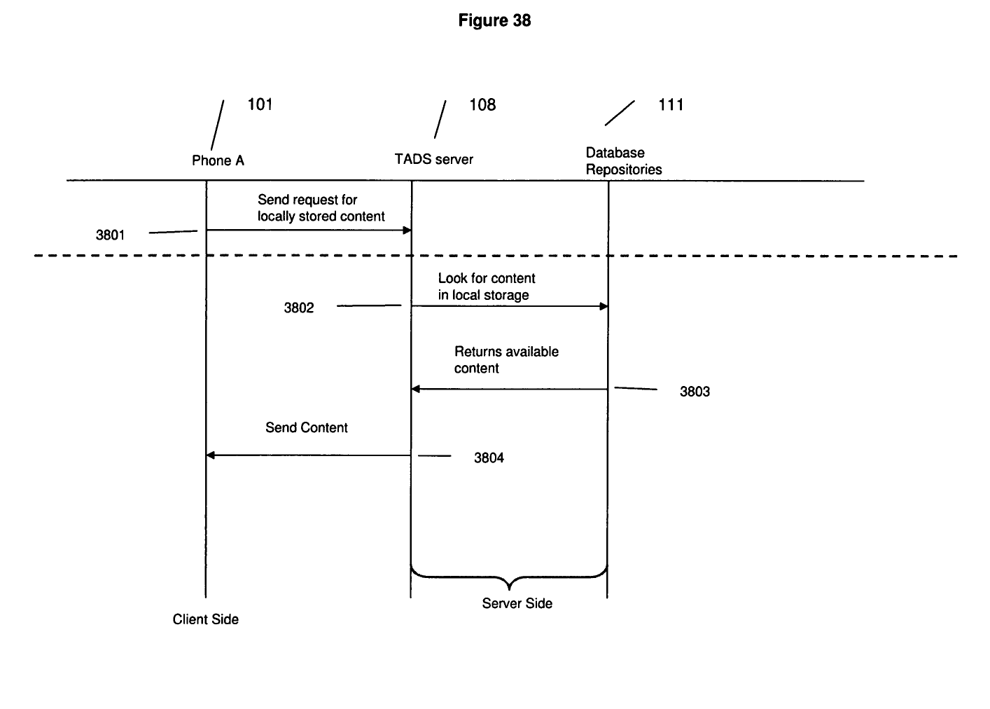

FIG. 38 shows (via arrows as indicated below) the sequence of events associated with handling local content requests in accordance with an embodiment of the present invention. A phone requests local content for its profile from TADS server 108 (arrow 3801). TADS server 108 searches for cached content on local data repositories 111 (arrow 3802) and sends the content to phone A 101 (arrow 3804) via TADS server 108 (arrow 3803).

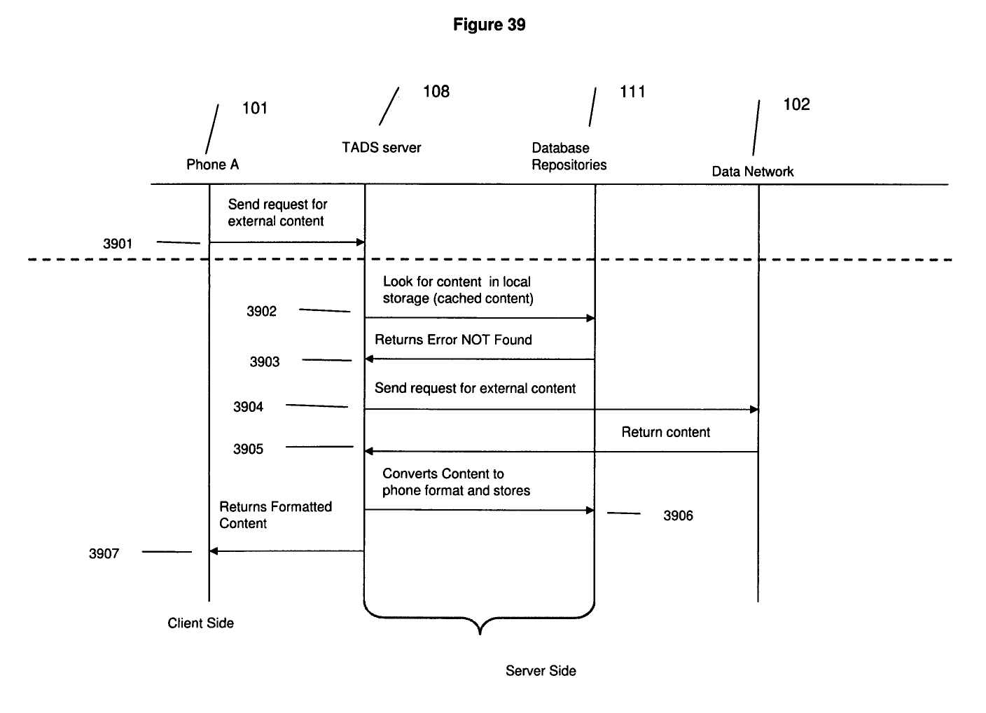

FIG. 39 shows (via arrows as indicated below) the sequence of events associated with, handling external content requests in accordance with an embodiment of the present invention. Phone A 101 sends a request to TADS server 108 for external content (arrow 3901). TADS server 108 first looks for a cached copy of the requested content in local storage (arrow 3902). If there is a cached copy, the sequence would be exactly as that depicted in FIG. 38. If there is not a cached copy, TADS server 108 will receive an “Error—not found” message (arrow 3903). TADS server 108 then will request external content via the external content via the data network 102 (arrow 3904). Once TADS server 108 receives the requested external content (arrow 3905), it proceeds to reformat the content for the TADS-enabled device phone A 101 and store a cached copy in database repositories 111 (arrow 3906) and return the formatted content to phone A 101 (arrow 3907).

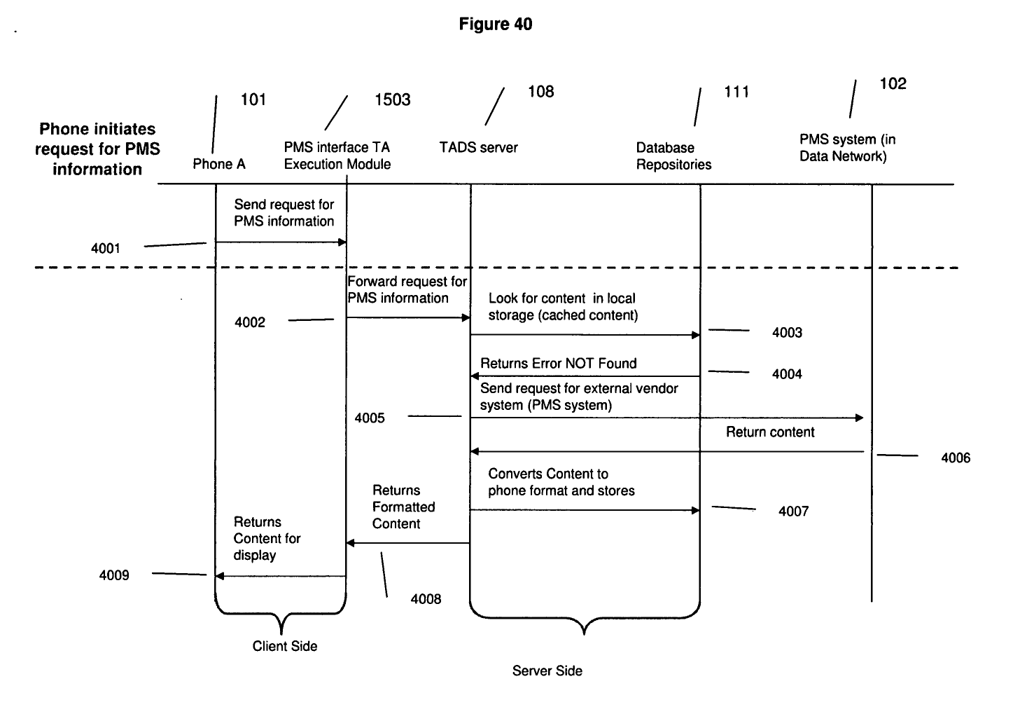

FIG. 40 shows (via arrows as indicated below) the sequence of events associated with handling PMS interaction in a hospitality setting in accordance with an embodiment of the present invention. Phone A 101 sends a request (arrow 4001) for PMS information (e.g., billing information) to TADS server 108 (arrow 4002) via a PMS interface provided by TA execution module 1503. TADS server 108 searches for cached content on the local database repositories (arrow 4003). If there is a cached copy, the sequence would be exactly as that depicted in FIG. 38. If there is not a cached copy, TADS server 108 will receive an “Error—not found” message (arrow 4004). TADS server 108 then will request content from the PMS system via data network 102 (arrow 4005). Once TADS server 108 receives the requested external content (arrow 4006), it proceeds to reformat the content for the TADS-enabled device phone A 101 and store a cached copy in database repositories 111 (arrow 4007) and return the formatted content to phone A 101 (arrow 4009) via the PMS interface provided by TA execution module 1303 (arrow 4008).

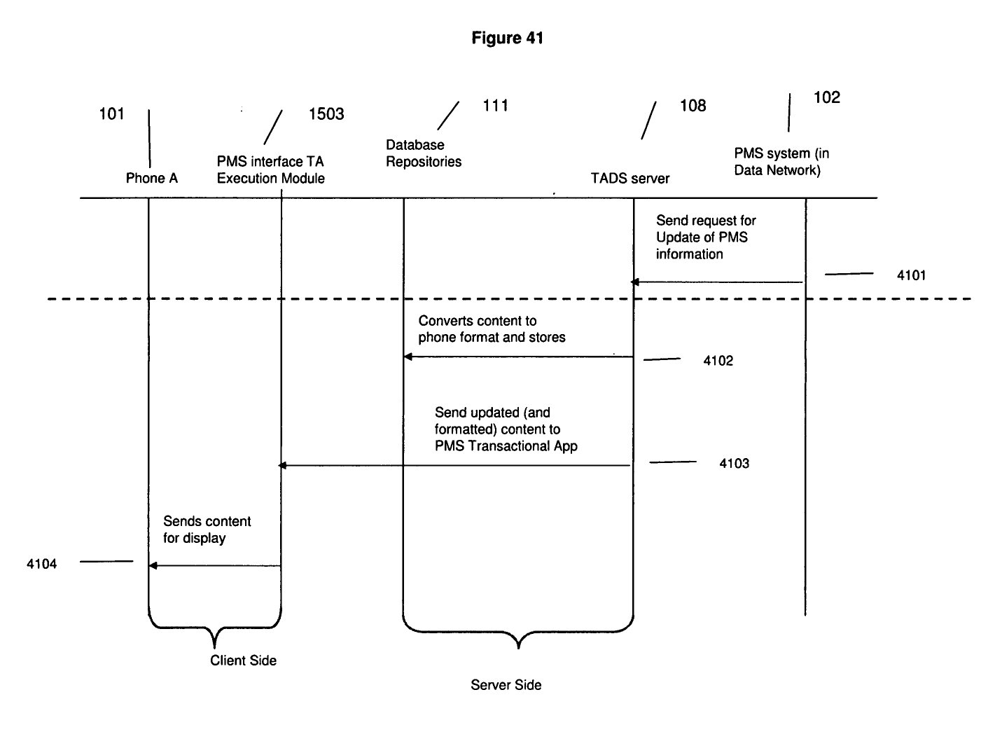

FIG. 41 shows (via arrows as indicated below) the sequence of events associated with handling PMS interaction in a hospitality setting in accordance with an embodiment of the present invention when it is the PMS that initiates a request for the update of PMS information on a phone (e.g., update the guest name in a room). The PMS system makes a request to TADS server 108 via the data network 102 to update PMS information associated with Phone A 101 (arrow 4101). TADS server 108 converts the PMS-related content to a form suitable for phone A 101 and stores it on database repositories 111 (arrow 4102) and sends the updated and formatted content to the PMS interface provided by TA execution module 1503 (arrow 4103), which in turn sends the content to phone A 101 for display (arrow 4104).

An embodiment of the present invention is a framework for software module deployment, update and configuration (in reference to FIG. 11). A Transactional Application (TA) can be thought of as a software module. Such a framework will be hosted by the Applications and TADS server 108 and will work in conjunction with the Deployment and Configuration Services software on IP phone 101 to maintain individual software modules up to date and with the proper configuration. The Deployment and Configuration Services are part of Other Services 502. Deployment of software to an IP Phone 101 can be based on demographics taken from the Demographics Module 1007 or by selections of groups of IP Phones 101 made by a maintenance technician. Once a phone is selected as a software deployment candidate, communication is started between the TADS Server 1000 and the IP Phone 101 to complete the deployment, update and/or configuration operation. Communication is based on HTTP messages which contain XML data in its body. The format of this data is part of the TADS Protocol Family 1000 (discussed in association with FIG. 10 below).

FIG. 42 presents the message exchange between the A TADS Server 108 and the IP phone 101 during a software deployment and update operation 4200. An optional DEPLOY message 4201 can be sent by the Applications and TADS Server 108 to trigger the operation. IP phone will respond with an OK message 4202. IP Phone 101 will initiate the deployment and update procedure sending a REQUEST_INFO message 4203 to the Applications and TADS Server 108. This message includes information on the current version of the hardware and software (per module) available to software modules on IP Phone 101 and the module interdependency information to be used to decide what modules can be updated.

The Applications and TADS Server will respond with a RESPONSE_DEPLOY_INFO message 4204 to indicate any available updates for independent software modules and the dependencies with other modules. An example of the contents of this message follows: Multiple FTP sessions exchanging FTP messages 4205, 4206, 4207 and 4208 can be established with the Applications and TADS Server 108 or a Vendor Server 118 to download individual software modules to IP Phone 101. Messages SEND_DATA 4209 and START_UPDATE 4210 are optionally exchanged between the Applications and TADS Server 108 and IP Phone 101 to backup configuration data.

FIG. 43 presents the message exchange between the Applications and TADS Server 108 and an IP Phone 101, during a software configuration operation 4300. Applications and TADS Server 108 can optionally send a CONFIGURE message 4301 to trigger a configuration procedure. IP Phone 101 will send OK message 4302 in response to the CONFIGURE message 4301. IP Phone will in turn send a REQUEST_INFO message 4303 to Applications and TADS Server 108 requesting configuration information. Applications and TADS Server 108 will respond with a RESPONSE_CONFIGURE_INFO message 4304, containing any new or different configuration information for independent software modules.

Although the method, computer program product and system are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

What is claimed is:

1. A method for identifying phone numbers that did not contact intended recipients made by a user of an Internet Protocol (IP) phone comprising the steps of:
sending an error message to said IP phone by a server indicating a dialed phone number made by said user of said IP phone failed to connect;
receiving an alarm message from said IP phone indicating a phone number that did not contact an intended recipient;
incrementing a failure count for said phone number that did not contact said intended recipient; and
flagging said phone number that did not contact said intended recipient if said failure count exceeds a threshold.

2. The method as recited in claim 1 further comprising the steps of:
displaying an indication of a failed telephone call by said IP phone; and
triggering said alarm message to be sent to said server.

3. The method as recited in claim 1 further comprising the step of:
launching an investigation to determine why said failure count associated with said phone number that did not contact said intended recipient exceeded said threshold.

4. The method as recited in claim 1, wherein said alarm message is generated by said IP phone automatically in response to receiving said error message.

5. A method for identifying a failed directory search of a contact performed by a user of an Internet Protocol (IP) phone comprising the steps of:
sending an error message to said IP phone by a server indicating a directory search performed by said user of said IP phone failed to identify said contact with a phone number;
receiving an alarm message from said IP phone indicating an improper graphic;
incrementing a failure count for said searched contact; and
flagging said directory search if said failure count exceeds a threshold.

6. A computer program product embodied in a machine readable medium for identifying phone numbers made by a user of an Internet Protocol (IP) phone that did not contact intended recipients comprising the programming steps of:
sending an error message to said IP phone indicating a dialed phone number made by said user of said IP phone failed to connect;
receiving an alarm message from said IP phone indicating a phone number that did not contact an intended recipient;
incrementing a failure count for said phone number that did not contact said intended recipient; and
flagging said phone number that did not contact said intended recipient if said failure count exceeds a threshold.

7. The computer program product as recited in claim 6, wherein said alarm message is generated by said IP phone automatically in response to receiving said error message.

8. A computer program product embodied in a machine readable medium for identifying a failed directory search of a contact performed by a user of an Internet Protocol (IP) phone comprising the programming steps of:
sending an error message to said IP phone indicating a directory search performed by said user of said IP phone failed to identify said contact with a phone number;
receiving an alarm message from said IP phone indicating an improper graphic;
incrementing a failure count for said searched contact; and
flagging said directory search if said failure count exceeds a threshold.

9. A system, comprising:
a memory unit operable for storing a computer program operable for identifying phone numbers made by a user of an Internet Protocol (IP) phone that did not contact intended recipients; and
a processor coupled to said memory unit, wherein said processor, responsive to said computer program, comprises:
circuitry for sending an error message to said IP phone indicating a dialed phone number made by said user of said IP phone failed to connect;
circuitry for receiving an alarm message from said IP phone indicating a phone number that did not contact an intended recipient;
circuitry for incrementing a failure count for said phone number that did not contact said intended recipient; and
circuitry for flagging said phone number that did not contact said intended recipient if said failure count exceeds a threshold.

10. A system, comprising:
a memory unit operable for storing a computer program operable for identifying a failed directory search of a contact performed by a user of an Internet Protocol (IP) phone; and
a processor coupled to said memory unit, wherein said processor, responsive to said computer program, comprises:
circuitry for sending an error message to said IP phone indicating a directory search performed by said user of said IP phone failed to identify said contact with a phone number;
circuitry for receiving an alarm message from said IP phone indicating an improper graphic;
circuitry for incrementing a failure count for said searched contact; and
circuitry for flagging said directory search if said failure count exceeds a threshold.

11. A method comprising the steps of:
receiving a first wakeup call to an Internet Protocol (IP) phone from a server;
receiving one or more of reminders, alerts, newspaper material and a list of information categories from said server if said first wakeup call is confirmed by a user of said IP phone; and
receiving a second wakeup call after a particular time period specified in a profile of said user if said first wakeup call is not confirmed by said user of said IP phone.

12. The method as recited in claim 11 further comprising the steps of:
automatically answering said first wakeup call if said first wakeup call is flagged as a wakeup call by said IP phone;
contacting a second server to obtain preferences of said user of said IP phone; and
connecting to said second server to transmit audio to said IP phone.

13. The method as recited in claim 12 further comprising the step of:
disconnecting said first wakeup call if said user does not confirm said first wakeup call.

14. The method as recited in claim 11 further comprising the steps of:
automatically answering said first wakeup call if said first wakeup call is flagged as a wakeup call by said IP phone;
playing an appropriate ringtone;
signaling that said user has answered said first wakeup call to said server upon said user answering said first wakeup call; and
connecting to a second server to transmit audio to said IP phone.

15. The method as recited in claim 11, wherein said one or more of said reminders, alerts, newspaper material and said list of information categories comprises a list of gift categories and a list of vendors for each gift category listed, wherein the method further comprises the steps of:
selecting a vendor from said list by said user of said IP phone;
placing an order with said vendor by said user of said IP phone; and
posting a transaction with a second server associated with said vendor.

16. The method as recited in claim 11, wherein said one or more of said reminders, alerts, newspaper material and said list of information categories comprises a list of entertainment events, wherein the method further comprises the steps of:
selecting an entertainment event from said list by said user of said IP phone;
placing an order by said user of said IP phone; and
posting a transaction with a second server associated with a vendor providing tickets to said selected entertainment event.

17. A method for contacting a merchant of an advertisement displayed on an Internet Protocol (IP) phone comprising the steps of:
receiving an advertisement on a webpage displayed on said IP phone, wherein said advertisement on said webpage includes session initiation protocol (SIP) based uniform resource identifiers (URIs);
selecting said advertisement;
passing a URI associated with said selected advertisement by a web browser of said IP phone to an application of said IP phone; and
generating a call to a merchant associated with said selected advertisement based on said URI associated with said selected advertisement by said application of said IP phone.

18. A method for generating a conference call from an Internet Protocol (IP) phone comprising the steps of:
creating a conference call meeting profile containing contact information for all conference participants in response to scheduling a meeting;
sending said conference call meeting profile to a first phone application of said IP phone, wherein said first phone application is configured to maintain a calendar of a first user of said IP phone;
executing said conference call meeting profile; and
instructing said IP phone to generate a conference call to said conference participants identified in said profile.

19. The method as recited in claim 18 further comprising the step of:
assigning an identification to said profile thereby allowing a user to have multiple defined profiles and be able to select among them.

20. A method for generating a conference call from an Internet Protocol (IP) phone comprising the steps of:
scheduling a meeting for identified conference participants by a user of said IP phone;
receiving profiles storing contact information for said identified conference participants;
receiving a notification that a conference call should be established; and
sending an invite message to each of said identified conference participants to establish communication with said IP phone.

21. A method for establishing a conference call with an Internet Protocol (IP) phone comprising the steps of:
storing a conference call meeting profile containing contact information for all conference participants, wherein said conference call meeting profile comprises a set of instructions which are to be followed upon activation of said conference call meeting profile;
receiving an indication to start a conference call associated with said conference call meeting profile;
activating said conference call meeting profile; and
inviting each of said conference participants to establish communication with said IP phone.

22. A method for controlling content distribution to and from an Internet Protocol (IP) phone comprising the steps of:
storing profile preferences of a profile in a database, wherein said profile preferences of said profile comprises rules as to which telephone calls and content are allowed to be received by a user of said IP phone and which telephone calls and content are forbidden to be received by said user of said IP phone;
associating said profile with a schedule, wherein said schedule enables different telephone calls and content to be received and forbidden at different times during the day;
receiving a request to send content to said user of said IP phone; and
determining if said user of said IP phone is allowed to receive said content based on said profile preferences of said profile.

23. The method as recited in claim 22 further comprising the step of:
sending an error message to a sender of said request to send content to said user of said IP phone if said user of said IP phone is forbidden from receiving said content.

24. The method as recited in claim 23 further comprising the step of:
assigning said sender and said user of said IP phone to a distribution group.

25. A method for controlling content distribution to and from an Internet Protocol (IP) phone comprising the steps of:
storing profile preferences of a profile in a database, wherein said profile preferences of said profile comprises rules as to which telephone calls and content are allowed to be received by a first user of an IP phone and which telephone calls and content are forbidden to be received by said first user of said IP phone;
associating said profile with a schedule, wherein said schedule enables different telephone calls and content to be received and forbidden at different times during the day;
receiving a request by a second user to telephonically connect to said first user of said IP phone; and
determining if said first user of said IP phone is allowed to telephonically connect to said second user based on said profile preferences of said profile.

26. The method as recited in claim 25 further comprising the step of:
sending a message to said second user indicating that said first user of said IP phone is forbidden from connecting telephonically with said second user if said first user of said IP phone is forbidden from connecting telephonically with said second user.

27. The method as recited in claim 27 further comprising the step of:
assigning said second user and said first user to a distribution group.

28. A method for a user to access content on an Internet Protocol (IP) phone from a hotel comprising the steps of:
generating a content package to be displayed on said IP phone, wherein said content packages comprise customized content, wherein said content package comprises one or more of the following: check-in/check-out assistance and information, billing information, room service orders, and concierge services information;
transmitting said content package to said IP phone; and
providing a user of said IP phone with controls to access content of said generated content package.

29. The method as recited in claim 28, wherein said hotel includes a system configured to customize said content package.

30. The method as recited in claim 28, wherein said content package further comprises one or more of the following: informational content and recreational content.

31. A method for facilitating the management of directory updates comprising the steps of:
generating a validation code in response to a vendor performing one or more of updating, correcting and setting up a contact information associated with a phone line of interest;
sending said validation code along with a telephone number to call to an e-mail address of said vendor;
generating one or more of an electronic mail and a facsimile; and
sending said one or more of said electronic mail and said facsimile to said vendor indicating that said phone line contact information has been successfully updated.

32. A method for assigning content to Internet Protocol (IP) phones comprising the steps of:
storing content created by an administrator on a database repository;
assigning profiles to phone groups;
reading content identifications from said database repository and assigning said read content identifications to said phone groups; and
returning content corresponding to a requested identification.

33. The method as recited in claim 32 further comprising the steps of:
storing updated content in said database repository;
generating a message notifying of said updated content;
sending said generated message to an IP phone; and
sending said updated content to said IP phone.

34. The method as recited in claim 32 further comprising the steps of:
receiving a request for local content from an IP phone;
searching for said requested local content in said database repository; and
sending said requested local content to said IP phone.

35. The method as recited in claim 32 further comprising the steps of:
receiving a request for external content from an IP phone;
requesting said requested external content via a data network;
receiving said requested external content;
reformatting said received requested external content;
storing a copy of said reformatted requested external content in said database repository; and
sending said reformatted requested external content to said IP phone.

36. The method as recited in claim 33, wherein the method for assigning content to IP phones occurs in a hospitality setting.

37. The method as recited in claim 34, wherein the method for assigning content to IP phones occurs in a hospitality setting.

38. The method as recited in claim 35, wherein the method for assigning content to IP phones occurs in a hospitality setting.
